(19) United States
(12) Patent Application Publication
(10) Pub. No.: US 2006/0026162 A1
(43) Pub. Date: Feb. 2, 2006

(54) Content management system

(75) Inventors: Daniel R. Salmonsen, Saratoga, CA (US); Gerard J. Cerchio, San Francisco, CA (US)

Correspondence Address: GOODWIN PROCTER LLP;PATENT ADMINISTRATOR, EXCHANGE PLACE, BOSTON, MA, 02109-2881, US

(73) Assignee: Zoran Corporation, Sunnyvale, CA (US)

(21) Appl. No.: 10/895,251

(22) Filed: Jul. 19, 2004

(51) Int. Cl. G06F 17/30

(52) U.S. Cl. 707/10

(57) ABSTRACT

A content handling method comprises acquiring content from one or more sources including sources capable of network connection and/or sources capable of local connection. The content and sources are capable of dynamic change. The method further comprises dynamically configuring a user interface that enables selection and access of the content, the dynamic configuring being user-transparent.

### BACKGROUND

In a wide range of applications, devices or appliances exist that perform a single function or only a few functions but have processing, storage and display capabilities that could greatly extend functionality if exploited. Examples of these devices and appliances include televisions, digital video cassette recorders, digital versatile disk players, audio receivers, digital portable entertainment devices, point-of-sale terminals, process controllers and valves, vending machines, alarm systems, home appliances, and many more. Computational power and capabilities of the devices increases as technology evolves and additional software solutions become available, improving user and customer services and experiences with successive product generations. The devices and appliances typically have a dedicated function and unique architecture and, generally, are not designed for interaction with other device or model types, or even with others of the same device.

Technological advances have created availability of a vast amount of information in many different formats that is accessible by computer networks such as intranets, local area networks, wide area networks, and the internet. The networks allow easy access to information throughout the world and facilitate information delivery world-wide in the form of text files, data, motion pictures, video clips, music files, web pages, flash presentations, shareware, computer programs, command files, and other information. One obstacle to access and delivery of information is lack of interoperability and resource management among devices and content formats. Another problem is an inability to navigate the infinite combinations of sources, content, and formats that are constantly changing and updating.

### SUMMARY

A content handling method comprises acquiring content from one or more sources including sources capable of network connection and/or sources capable of local connection. The content and sources are capable of dynamic change. The method further comprises dynamically configuring a user interface that enables selection and access of the content, the dynamic configuring being user-transparent.

### BRIEF DESCRIPTION OF THE DRAWINGS

The features of the described embodiments believed to be novel are specifically set forth in the appended claims. However, embodiments of the invention relating to both structure and method of operation, may best be understood by referring to the following description and accompanying drawings.

FIG. 1 is a schematic block diagram illustrating an embodiment of a media interface system that facilitates content handling and enables a user device 102 to acquire and perform content acquired from a local server and a remote server.

FIGS. 2A, 2B, 2C, and 2D are schematic use case diagrams respectively showing embodiment of a server use case, client and server management use cases, media management use cases, and client use cases.

FIG. 3 is a detailed state diagram illustrating an example of functions performed by an emulator.

FIG. 4 is a schematic block diagram depicting an embodiment of a media tree that functions as a network-distributed resource.

FIG. 5 is a schematic state diagram showing an embodiment of a client media server.

FIG. 6 is a use case diagram illustrating an embodiment of a media transcoder system including operations between a user device server and a media transcoder.

FIG. 7 is a component diagram showing various system, hardware, and software components of a server for usage with an emulator interface.

FIGS. 8A, 8B, and 8E are timing diagrams respectively illustrating various system interactions.

FIGS. 8C and 8D respectively show a schematic use case diagram for server coordination interactions between a primary server and a secondary server, and a state diagram illustrating Server Discover protocol operation.

FIG. 9 is a schematic sequence diagram illustrating an embodiment of an interaction between a server and a media transcoder.

FIG. 10 is a sequence diagram depicting interactions of a Simple Object Access Protocol (SOAP) media definition server that supports media tree modification.

FIG. 11 is a use case diagram showing functionality of an audio-visual system that uses an emulator interface.

FIGS. 12A and 12B are a flow chart and sequence diagram respectively illustrating operations of a boot Read-Only Memory.

FIGS. 13A and 13B are, respectively, a schematic state diagram depicting an embodiment of drive controller, and a flow chart illustrating an embodiment of drive interface operations.

FIG. 13C is a schematic flow chart illustrating an embodiment of operations performed by the client to implement UDP protocol communication, enabling rapid packet transmission without TCP overhead.

FIG. 14A is a schematic block diagram illustrating an embodiment of a media arrangement that can be used by the system.

FIG. 14B depicts an embodiment of a media directory.

FIG. 14C is a linked menu diagram showing an embodiment of a Linked Menu Convention (LMC) which enables the application and the client to present to the user a series of menus with a consistent look and feel.

FIG. 14D is a flow chart illustrating an embodiment of a code segment added to program code for information format (IFO) in cases that TCDR_LinkedMenu option is called on a transcoder.

FIG. 15 is a schematic block diagram showing an embodiment of an eXtended Markup Language (XML) media schema.

FIG. 16 is a detailed block diagram that depicts functional blocks of an emulation circuit that is suitable for usage in the emulator interface.

### DETAILED DESCRIPTION

What are desired are devices and systems capable of handling widely differing and disparate media devices such as media players and personal computers, and a capability to navigate constantly and dynamically changing content in a high-connectivity system. Multiple multimedia consumer electronic devices and computer systems can be interconnected using wired and/or wireless networks, enabling playback of large format storage-based music, photographs, and video content on AV systems and connected consumer electronic devices. The large format storage and large-capacity hard disk drives can reside, for example, in a Personal Computer (PC) or an entertainment content aggregation system, like a Set Top Box or TIVO Personal Video Recorder (PVR). The illustrative system generates a user interface enabling navigation through media made available from remote and/or local sources while the sources and content are dynamically changing and updating as additional sources and content become available. The illustrative system generates such a dynamically changing user interface without changing the look-and-feel of traditional consumer devices.

In one illustrative embodiment, a DVD player-to-PC connection and an Ethernet IC with no changes to the player's firmware, enables users to view content over a home network without buying specialized hardware. The players can automatically detect the presence of the network and server without interfering with normal playing of a DVD disk. An interface-enabled DVD player enables consumers to easily access all types of Personal Computer (PC)-based audio-visual media content for presentation on home theater equipment without incurring the enormous expense of proprietary, nonstandard electronics, and without struggling to interconnect multiple different systems with disparate interfaces. One example supports widely varying media types including all MPEG, Windows Media, QuickTime, DiVX video formats, JPEG, MP3, WMA, and other still image and music formats, as well as formats not supported by a DVD player.

The interface and software leverage microprocessor power to supply content to a media device, for example a Digital Versatile Disk (DVD) player connected to a television monitor, in a supported format. The software element in the interface enables communications between the consumer electronic devices and microprocessor media management application software. The illustrative system improves the effectiveness of both the PC as a content-aggregation and media-management tool, and the DVD player as a flexible, feature-rich, easy-to-use playback device. Although details may vary, the PC in the illustrative embodiment can be replaced by a set top box with PVR capabilities, for example, and the DVD player can be replaced by a portable handheld entertainment device, perhaps even a multimedia enabled mobile telephone with a large format Liquid Crystal Display (LCD) screen, for example.

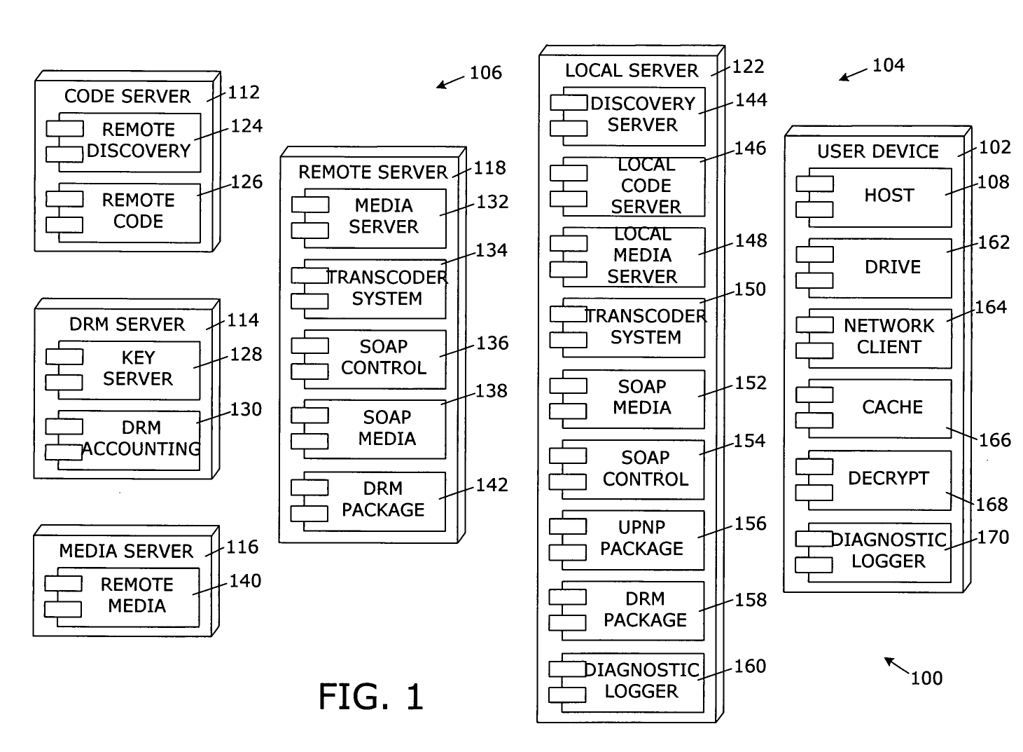

Referring to FIG. 1, a schematic block diagram illustrates an embodiment of a media interface system 100 that facilitates content handling and enables a user device 102 to acquire and perform content acquired from a local server 104 and a remote server 106.

In common operation, when a user device 102 that has yet to be used engages with the media interface system 100, a process is initiated in which local server 104 and remote sever 106 are searched in an effort to find individual content references as well as content reference “groups”. The groups can be in the form of “user preference modules” and/or “user profile” play lists of related entertainment content. The references found are automatically, without user involvement or intervention, aggregated and incorporated into a menuing system of user device 102. The user can now select, for viewing, listening or both, content related to the aggregated content references. In the case of user preference modules and profiled content, the selection of a particular module or profile enables all the content in the module or profile to be available to the user. The selection of a profile menuing item by the user, for example, could bring up the display of another menu. The new menu can show content selections from the selected profile. In the case that a user device 102 has already been initialized in the described manner, the act of engaging the user device 102 with the media interface system 100 starts an update process which gleans new, different, and/or updated content references from servers 104 and 106 in comparison to the references already found in the menuing system of user device 102. The newly acquired references are used to refresh the content references already incorporated in the user device menuing system.

For significant convenience to the user, the illustrative system supports “user preference modules” and/or “user profiles” that can be easily prepared by commercial ventures and/or other users willing to share lists of content references that are believed to be of interest to the user. Plain text formats as well as significantly more sophisticated public private key encrypted formats, in combination with tools for preparing such lists in appropriate formats, are well known.

The user device 102 includes a host 108, generally a controller or processor, which acquires content from one or more sources including remote sources that communicate with the user device 102 via the remote server 106 and a network connection, and local sources via the local server 104. The content and sources can change dynamically. The host 108 dynamically configures a user interface that enables selection and controls access to content in a user-transparent manner.

Remote components 106 of the media interface system 100 include a code server 112, a Digital Rights Management (DRM) server 114, a media server 116, and a remote interface server 118. Local components 120 include a local interface server 104 and the user device 102 and supplies services that are available either locally or remotely. Remote services are contained within network nodes that are not constrained to be within the local segment 120.

The code server 112 contains a remote discovery server 124 and remote program code 126. The code server 112 runs client code such as downloading of program code modules to clients.

The Digital Rights Management (DRM) server 114 contains a key server 128 and Digital Rights Management (DRM) accounting functions 130. A memory, such as a boot Read-Only Memory (RAM), can contain encryption keys. For example, code downloaded by a boot ROM may be constrained to be digital signature analysis (DSA)-signed. A public key cryptography system enables the boot ROM to contain the public decryption key that prevents the encryption key from being available for any other entity to produce Client software images. Signature bytes can be prepended to the download image, which can be sent as a clear text image. Signing and verification can be performed using OpenSSL (www.openssl.org). In the illustrative embodiment, encryption strength is 1024 bits. The private key is not published.

The media server 116 contains remote media 140. The media server 116 supplies media to the clients.

The remote interface server 118 contains a media server 132, a remote transcoder system 134, a Simple Object Access Protocol (SOAP) control block 136, SOAP media 138, and a Digital Rights management (DRM) package 142. The Simple Object Access Protocol is an eXtended Markup Language (XML) that defines use of XML and Hyper-Text Transport Protocol (HTTP) to access services, objects, and servers in a platform-independent manner. The SOAP media definition server 138 communicates between a media-building application and the server to facilitate application independence. The two applications may reside on the same device or component, or on widely separated components. SOAP ensures industry standard transport of the specific media control information.

The local interface server 104 contains a local discovery server 144, a local code server 146, a local media server 148, a local transcoder system 150, local SOAP media 152, a local SOAP control block 154, a Universal Plug'N'Play (UPNP) package 156, a local Digital Rights Management (DRM) package 158 and a diagnostic logger 160. The various components of the local interface server 104 may all execute within one node or may be distributed across multiple nodes, either on a single network segment or across multiple networks. A Client coder server may operate as an internet remote server enabling client installation into an environment with hardware as simple as a network modem with Dynamic Host Configuration Protocol (DHCP) services.

The discovery server 144 coordinates other servers and clients. The media server 148 supplies media to the clients. The code server 146 performs application firmware code for usage by clients. The client code server 146 downloads strongly encrypted, signed program code modules to clients. In one example embodiment, the download method can be a variation of Trivial File Transfer Protocol (TFTP) that is modified for efficiency and client recognition.

Transcoder system 150 converts media and navigation information to client format. SOAP control block 154 enables query operations and setting of server parameters. SOAP media 152 enables query operations and setting of server media. UPNP package 156 integrates the server into the Universal Plug and Play environment. DRM package 158 enables accounting for user payment for play media. Diagnostic logger 160 supplies debugging support for developers. The server supplies a telnet protocol Internet remote computing connection that emits a controllable diagnostic stream as the various components operate. The diagnostic stream and associated controls are viewable using a Server Console application.

The real-time transcoder system 150 generates menus and converts media in real-time to the media target format. Various functions performed by the transcoder include filtering, estimating filter parameters, initializing filters, creation of menu buttons, getting media packets, getting Information Format (IFO), getting static IFOs, releasing buffers, releasing estimates, setting options.

In the illustrative embodiment, the user device 102 can contain the host 108 which can also be called a drive emulator, at least one internal media drive 162 which can also be called a drive controller, a network client 164, a cache memory 166, a decryption engine 168, and an internal device diagnostic logger 170. The user device 102 can operate as a client. In an illustrative embodiment, the host or drive emulator 108 can manage operations relating to an MPEG decoder. The drive emulator 108 enables the system to operate in the manner of a device or component, for example a DVD drive with respect to interactions with an MPEG player. The drive emulator 108 can circumvent operations in the MPEG-DVD drive connection pathway and enter a pass-through mode of operation, enabling the MPEG player to operate on media within the drive. During the pass-through operating mode, the drive emulator 108 allows the client to monitor all commands sent to the drive and simultaneously intervene. The user device or client 102 has a suitable server interface for communicating with a server. In an illustrative embodiment, a server interface can be through 100 Base T Ethernet. Transmission Control Protocol (TCP) can be used to convey commands to the server and data may be returned either through the same TCP socket of a parallel User Datagram Protocol (UDP) socket. The user device or client 102 also has an appropriate host interface, for example using hardware that emulates an Integrated Drive Electronics (IDE) drive allowing the full AT Applications Program Interface (ATAPI) command set.

The drive controller 162 is optional and can manage devices such as mass storage devices that are native to the emulator-enabled user device 102. The network client 164 supplies communication capability to the server. The cache memory 166 intelligently retains and pre-fetches media data. The user device or client 102 has a read-ahead cache 166 for media data and also can have an optional permanent cache for server-specified “sticky” blocks. The decryption component 168 performs real-time decryption of the media. The diagnostic logger 170 is optional and can assist in development of the system. The client 102 supplies a real-time configurable diagnostic stream to a client console. The client 102 can use a diagnostic command shell with an extensive command set, enabling multiple diagnostic tests. Output categories for the data logger 170 include LogError that supplies indication of any error, LogInfo supplying an informational log item, LogDetail supplying detailed state information, LogSystem indicating system-related messages, and LogNet to generate networking messages. Other output categories include LogIDE supplying IDE-generated messages, LogTimer giving timing indications, LogCmd supplying information concerning ATAPI commands, LogHClnt giving network client information, and LogCDB depicting low level CDB messages. LogBCache, LogCmdPrc, BoardIO, and CBDAddr respectively give information concerning bcache activity, command processing activity, board input/output processing, and command and LBA information. MaxDetail, MidDetail, and MinDetail give varying amounts of information.

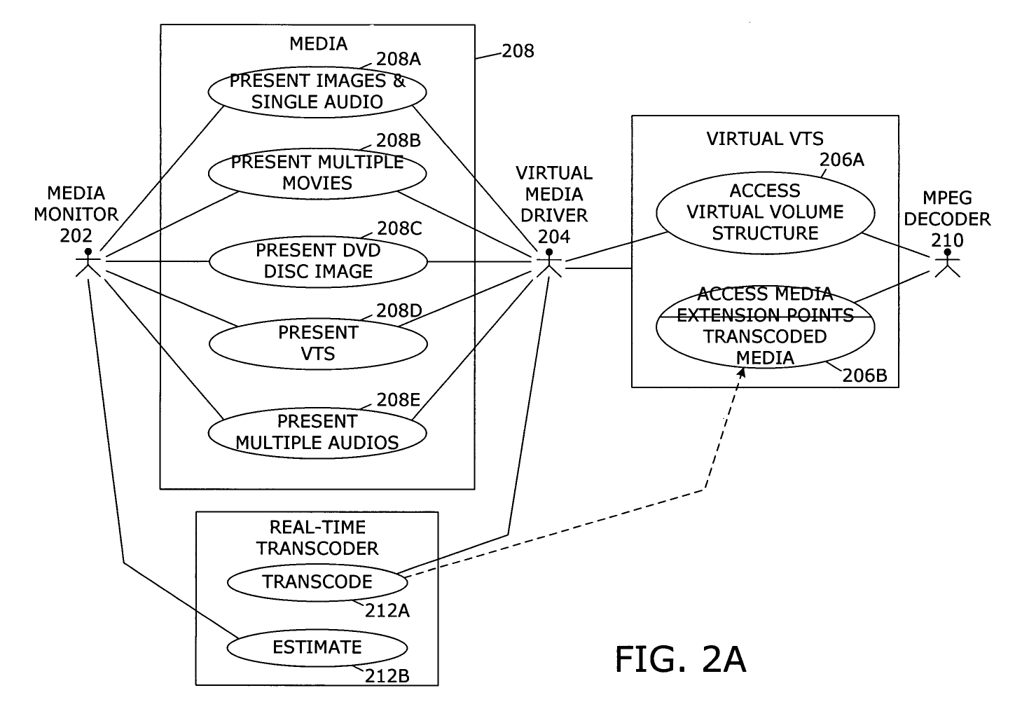

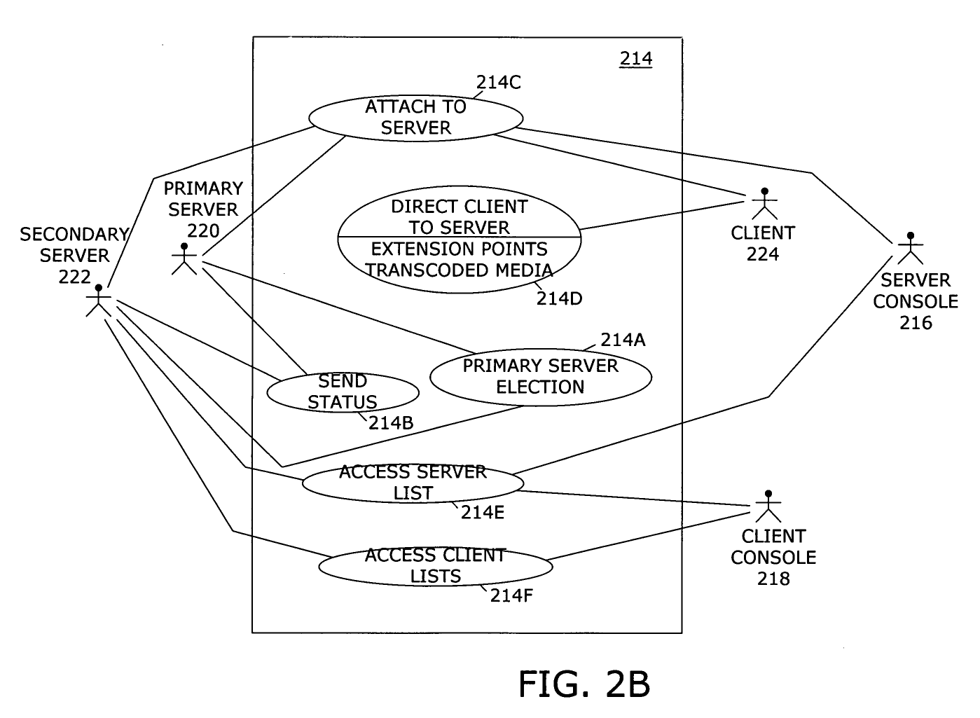

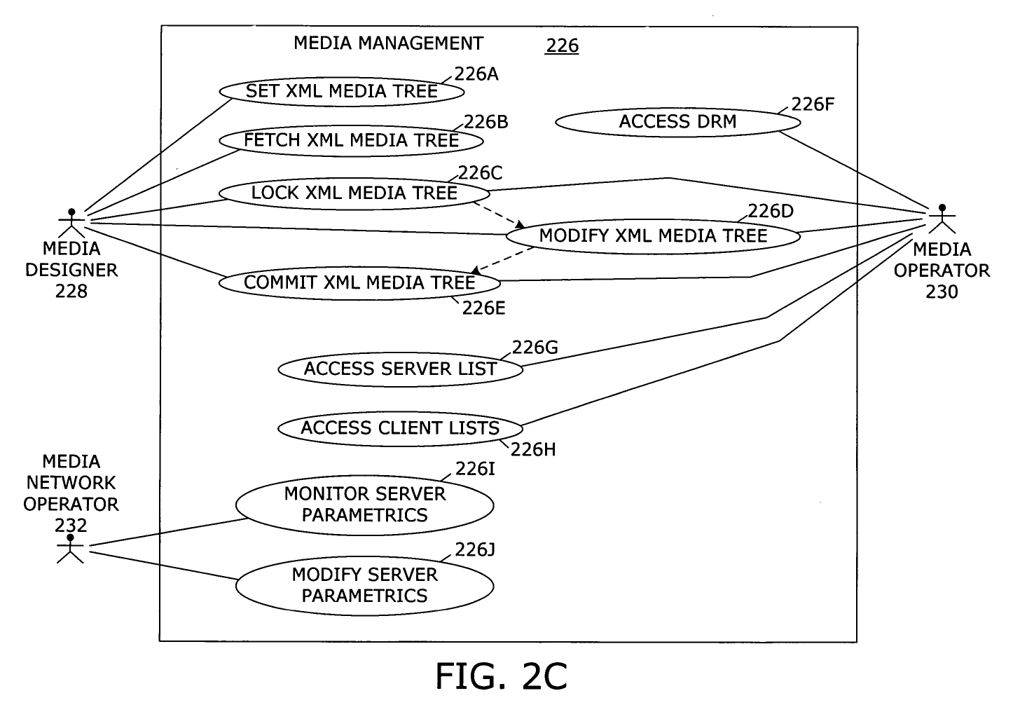

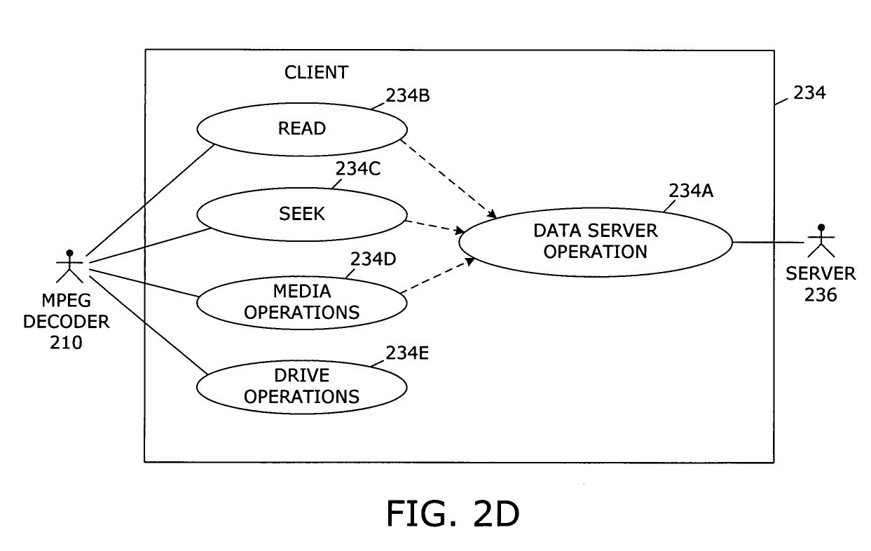

Referring to FIG. 2A, a schematic use case diagram depicts an embodiment of a server use case 200 that may be implemented, for example, in servers such as the local media server 148 the remote media server 132 shown in FIG. 1, and the like. Server use cases 200 may be illustrated as two active users—a media monitor 202 and a virtual media driver 204—arranging the media into a virtual volume 206 so that user devices may access media 208. The media monitor 202 supplies streaming media from multiple various media content sources. The virtual media driver 204 arranges and stores the media content in a virtual file structure. Use cases in the virtual volume 206, for example an interface Video Title Set (VTS), pass information between the virtual media driver 204 and a third user, a Moving Pictures Expert Group (MPEG) decoder 210. The server 200 also can include a real-time transcoder 212 that transcodes media to communicate between the media monitor 202 and the virtual media driver 204.

The media 208 use cases present various content types to the virtual media driver 204 including presenting images and audio content 208A, presenting multiple movies 208B, presenting disc images 208C such as Digital Versatile Disk (DVD) images, presenting a Video Title Set (VTS) 208D, and presenting multiple audio channels 208E.

The interface virtual Video Title Set (VTS) 206 use cases dynamically, in absence of user interaction, control access to information including virtual volume structures 206A and media extension points 206B for transcoded media.

The real-time transcoder 212 has use cases for transcoding media 212A and estimating 212B.

Referring to FIG. 2B, a schematic use case diagram shows an embodiment of client and server management use cases 214. A stand-alone application called a Console Server can supply user consoles capable of connecting to a server to enable monitoring and configuration of the server. An instance of a server console 216 can be connected to each server on a network.

A stand-alone application called a Console Client can supply client consoles capable of connecting to an interface client for monitoring and configuring the client. An instance of a client console 218 can be connected to each server on the network. A stand-alone version of a client console can be made available for usage. The command console supports multiple text-based commands for displaying and writing to client registers as well as higher level commands. The console client enables entry of client commands and register values. Client commands include:

| Command | Description |
|---|---|
| Help | Print command list. |
| Version | Print version number. |
| Preg | Print register map, #s appear at changed registers. |
| PowerTest | Perform power-on-reset test. |
| FirmReset | Perform firmware reset and test. |
| Dump | Dump memory from designated address range. |
| Fill | Fill dump memory range with a pattern. |
| Reg | Read or set byte address in FPGA register space. |
| LogMask | Print/set the log mask. |
| MemTest | Test FPGA memory buffer. |
| <regname> | Print/set register value. |
| <signame> | Print/set signal value. |
| IDEaddr | Print/set IDE address master or slave. |
| GetIDEcmd | Wait for ATAPI command and then print the command. |
| PushData | Push data for current command in progress. |
| Wait | Wait for <signame> or <regname> to become a value. |
| ATAPI | Print ATAPI register set and signals. |
| Verbose | Activate/deactivate print messages. |
| TI | Set read wait timing loop. |
| Rdtoc<session><format> | Read server's TOC, arguments optional. |
| RunDemo | Start demo task. |
| StopDemo | Stop demo task. |
| MylP | Print client IP address. |
| Eject | Eject media. |
| InitBCache <size><gran> | Initialize the BCache using size memory and granularity. |
| StartBCache<ip><port> | Startup the BCache. |
| StopBCache | Stop the BCache. |
| NetSpeed | Test transfer speed to the server. |
| OpenTray | Open the disc tray. |
| CloseTray | Close the disc tray. |
| TUR | Send Test Unit Ready (TUR) to the drive. |
| MechStat | Get Mech Stat from the drive. |
| DriveReg | Print drives registers. |
| PassThrough<on\|\|off> | Set to pass-through mode. |
| DiscDetect <count> | Set number of TURs to wait for no disk. |
| WpBit | Return state of wpBit. |
| SetStream<sector_size> | Set sector size for Digital Stream Interface. |
| SendStream<#sectors><ssz> | Send stream data. |
| LoadList lba cnt<lba cnt> | Prepare list of sectors to send. |
| SendList <lba cnt> | Send loadlist optionally start at lba cnt. |
| SetIF <avb\|\|ata> | Set bus interface. |
| sysspeed <server ip> | Test speed while pushing avbus. |
| MemSpeed | Do SDRAM mem access with different cache settings. |
| icache <off\|\|on> | Set or report current setting. |
| dcache <off\|\|on<wt\|\|wb>> | Set or report current setting. |
| transfer lba cnt | Transfer data starting at lba for cnt blocks. |

Multiple servers, for example a primary server 220 and a secondary server 222 are allocated by primary server election 214A and coordinated via the Server Discovery Protocol 124, 144 in FIG. 1, and by a send status 214B use case. A client 224 attaches to a server 214C and is directed to a server 214D via use cases. Other use cases include accessing of server lists 214E and accessing of client lists 214F.

The Server Discovery Protocol is used between servers 220, 222 to coordinate the various servers and enable clients 224 and server console windows 216 to locate a suitable server. The primary server 220 is the coder server and the authority for supplying media tree root Internet Protocol (IP) and port numbers to clients. The primary server 220 has three use cases including attach to server 214C, send status 214B, and primary server election 214A use cases. The secondary server 222 has two additional use cases including access client lists 214F and access server lists 214E use cases. All clients attach to the primary server 220 which may or may not direct the client to a secondary server 222. Client and server management use cases 214 govern the interaction of the primary server 220 with the secondary server 222 in sharing client information and in sharing status information. The primary server election 214A use case includes server cooperation to select the primary. An ad-hoc collection of servers on a network segment cooperate to elect a primary server that coordinates activities of all servers, and to detect and recover from loss of the primary server or any other server. Clients 218 and server 216 console windows are capable of obtaining a list of all servers on the network segment. The interaction protocol efficiently minimizes network usage and disturbances to uninterested node (broadcast traffic). In an illustrative embodiment, evaluation of primary server assignment is limited to the primary server election use case 214A. No re-evaluation takes place for mere modification of a server's media tree.

Referring to FIG. 2C, a schematic use diagram illustrates an embodiment of media management use cases 226 that describe interactions of a media designer 228, a media operator 230, and a media network operator 232. The media designer 228 sets an XML media tree 226A and fetches the XML media tree 226B. Interactions between the media designer 228 and media operator 230 include locking the XML media tree 226C, modifying the XML media tree 226D, and committing the XML media tree 226E. The media operator 230 accesses Digital Rights Management (DRM) 226F information, such as keys, accesses server lists 226G, and accesses client lists 226H. The media network operator 232 monitors server parametrics 2261 and modifies server parametrics 226J.

Referring to FIG. 2D, a schematic use diagram illustrates an embodiment of client use cases 234 that describe interactions of the MPEG decoder 210 and a user device server 336. A data server operation 234A is an optional drive-pass-through use case that enables the user device to relinquish control and enable components, for example an MPEG player and a DVD drive, to interact as in any other media player environment. The data server operation 234A is a local media augmentation use case that enables the user device server 236 to monitor control information passing between the player and drive. The system may then perform operations affecting both the player and drive and obtaining data from the server 236. Information on the local media may then be augmented by content available from the server 236. Local media augmentation uses a media description that is merged from the drive and the server 236. Client use cases 234 include read 234B, seek 234C, media operations 234D, and drive operations 234E, that all may pass through the data server operation use case 234A.

In some embodiments, the client environment can be implemented in low-level read-only boot firmware and a large read/write memory area for client software execution. The boot read-only memory (ROM) can execute initial network configuration and downloading of client software from a coder server, either remote 112 or local 104 as shown in FIG. 1.

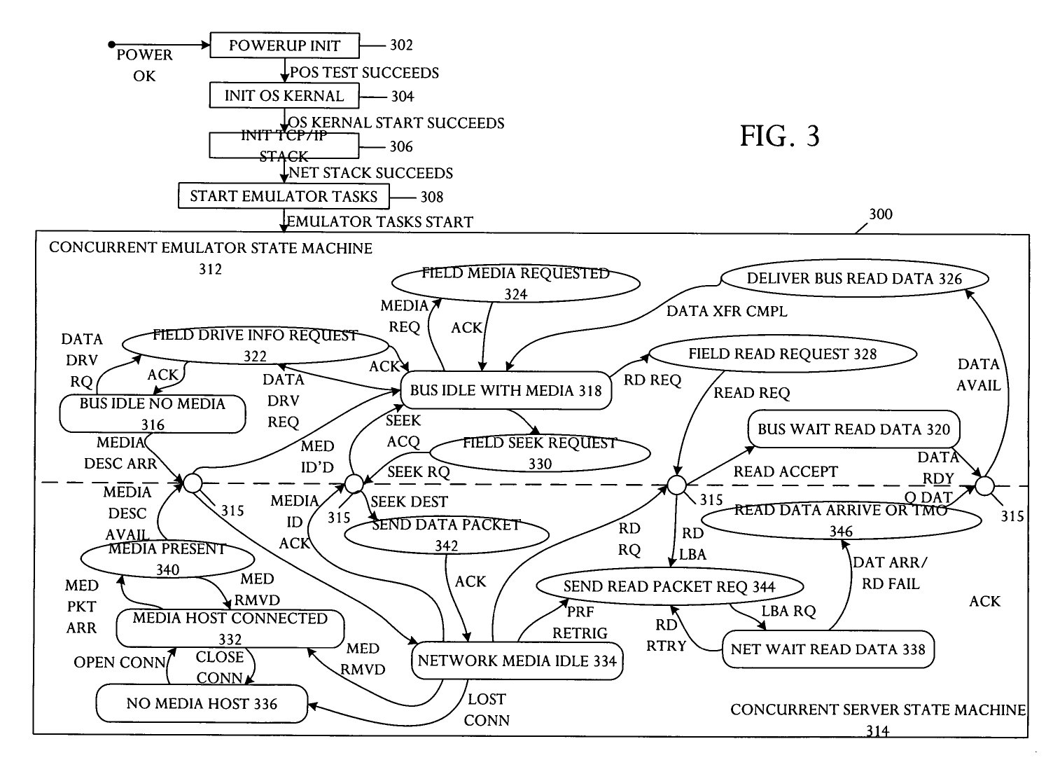

Referring to FIG. 3, a detailed state diagram illustrates an example of functions performed by an emulator 300. In various embodiments, the emulator 300 may execute one or more of a plurality of operations from various devices and components such as source devices, sink devices, or external devices.

In an emulation function, the emulator 300 generates control signals, data, and responses that deceive one or more of the source device, the sink device, and an external device as to the identity of the interacting device. In the sample of an optical media player with a network connection, an optical drive functions as a source, an optical media decoder serves as sink, and a remote computer operates as an external device. The emulator 300 can trick the devices so that the optical media decoder can render content from the remote computer in an interaction identical to an optical drive transaction. The optical drive can source content for the remote computer in an interaction identical to sourcing to the optical media decoder. For a writeable drive, the remote computer can source content for the optical drive in an interaction identical to writing to the drive from a bus.

Emulator 300 begins operation with a power-up initialization of hardware act 302 that proceeds when hardware tests are successful. Next an initialize operating system kernel act 304 initializes operation software. An initialize TCP/IP stack act 306 prepares an Ethernet stack for communication. A start emulator tasks act 310 commences operation of the emulator 300 including an emulator state machine 312 and a server state machine 314 that execute concurrently and synchronize at sync points 315.

The illustrative emulator state machine 312 has three wait states including a bus idle with no media 316, a bus idle with media state 318, and a bus wait read data state 320. The illustrative emulator state machine 312 has five command action states including a field drive information request state 322, a field media request state 324, a deliver bus read data state 326, a field read request state 328, and a field seek request state 330.

The illustrative server state machine 314 has four wait states including a media host connected state 332, a network media idle state 334, a no media host state 336, and a network wait read data state 338. The illustrative server state machine 314 has four action states including a media present state 340, a send seek packet state 342, a send read packet request state 344, and a read data arrives or timeout state 346.

The no media host state 336 advances to the media host connected state 332 when a media connection is open but returns when the connection is closed. Similarly, the network media idle state 334 returns to the no media host state 336 when a media connection is lost. The media host connected state 332 advances to the action media present state 340 when a media packet arrives but returns when the media is removed. When a media description is available, the emulator state machine 312 advances to the bus idle with media state 318 as the media is identified. The bus idle with media state 318 advances to the field drive information request state 322 upon a drive data request and returns on an acknowledge. The bus idle with media state 318 advances to the field media request state 324 upon a media request and returns on an acknowledge. The bus idle with media state 318 advances to the field read request state 328 on a read request, generating a read logical block address (LBA) signal that places the server state machine 314 in the send read packet request state 344. On a logical block address (LBA) request, the server state machine 314 advances from the send read packet request state 344 to the network wait read data state 338 and returns on a read retry. In the network wait read data state 338, the server state machine 314 advances to the read data arrives or timeout state 346 and, on a queue data signal, places the emulator state machine 312 in the deliver bus read data state 326. On a data transfer complete signal, the emulator state machine 312 enters the bus idle with media state 318 from the deliver bus read data state 326.

The bus idle no media state 316 of the emulator state machine 312 advances to the field drive information request state 322 upon a drive data request and returns on an acknowledge. The bus idle no media state 316 signals the server state machine 314 when a media descriptor arrives, generating a media ID acknowledge that places the server state machine 314 in the network media idle state 334. The network media idle state 334 in the event of a bus seek request, generates a seek acknowledge that places the emulator state machine 312 in the bus idle with media state 318. The bus idle with media state 318 advances to the field seek request state 330 on a bus seek. The field seek request state 330 upon a seek request generates a seek destination signal that places the server state machine 314 in the send seek packet state 342 which goes to the network media idle state 334 on an acknowledge.

The network media idle state 334 upon a read request generates a read accepted signal that places the server state machine 314 in the bus wait read data state 320. When data is ready in the bus wait read data state 320, an acknowledge places the server state machine 314 in the network media idle state 334.

Emulator 300 can determine functionality of a particular sink device and specifically imitate that functionality for a remote device. In a particular example, the emulator 300 can imitate a disk drive by generating one track or stream of MPEG-2 at a constant bit rate or variable bit rate of compressed digital video. The particular emulator 300 may support constant or variable bit rate MPEG-1, CBR and VBR video, at 525/60 (NTSC, 29.97 interlaced frames/sec) and 625/50 (PAL, 25 interlaced frames/sec) with coded frame rates of 24 fps progressive from film, 25 fps interlaced from PAL video, and 29.97 fps interlaced from NTSC video. Interlaced sequences can contain progressive pictures and macroblocks. The emulator 300 can place flags and signals into the video stream to control display frequency to produce the predetermined display rate. The emulator 300 can control interlacing, progressive frame display, encoding, and mixing. The emulator 300 can display still frames encoded as MPEG-2 I-frames for a selected duration, and can generate a plurality of subpicture streams that overlay video for captions, sub-titles, karaoke, menus, and animation.

The emulator 300 imitates a device that sources content by exhibiting the file system and methods of communicating with the file system of the source device. During initiation of a source-sink interaction, a system searches for contact on a source device. The emulator 300 mimics the file structure and content search of the source device in a remote device, permitting selection of content from either the actual source device or the remote device emulating the source device.

In a particular example, the emulator 300 emulates a file system such as a Universal Disk Format (UDF) or micro UDF file system and may support both write-once and rewritable formats. In some examples, the emulator 300 can support a combination of UDF, UDF bridge (ISO 9660), and ISO 13346 standards to ensure compatibility with legacy operating systems, players, and computers.

If an emulated transaction is selected, the emulator 300 manages the transaction by exchanging requests and data according to the protocols of a source-sink transaction. The emulator 300 also isolates the source device, intercepting and overriding control signals and data communicated by the source device and permitting signals and data interactions between the sink and the remote device as the emulated source. In various systems and transactions, the emulator 300 can imitate a transaction without notification of the sink device. In other systems and transactions, the emulator 300 can convey information to the sink device that indicates that emulation is occurring and identifying the actual remote content source, allowing additional control of network interactions, exploiting any additional capabilities of the remote device, and expanding rendering capabilities. For example, the emulator 300 can control a transaction to allow simultaneous rendering of content from the source device and an emulating remote device. One specific capability is a picture-in-picture display of source content and remote content. Another specific capability is enhanced web-enabled DVD that extends capabilities to combine content from a DVD with special network-accessed applications.

Software or firmware that is executable by the emulator 300 may include many functions such as media content navigation, user interfacing, servo firmware, and device drivers.

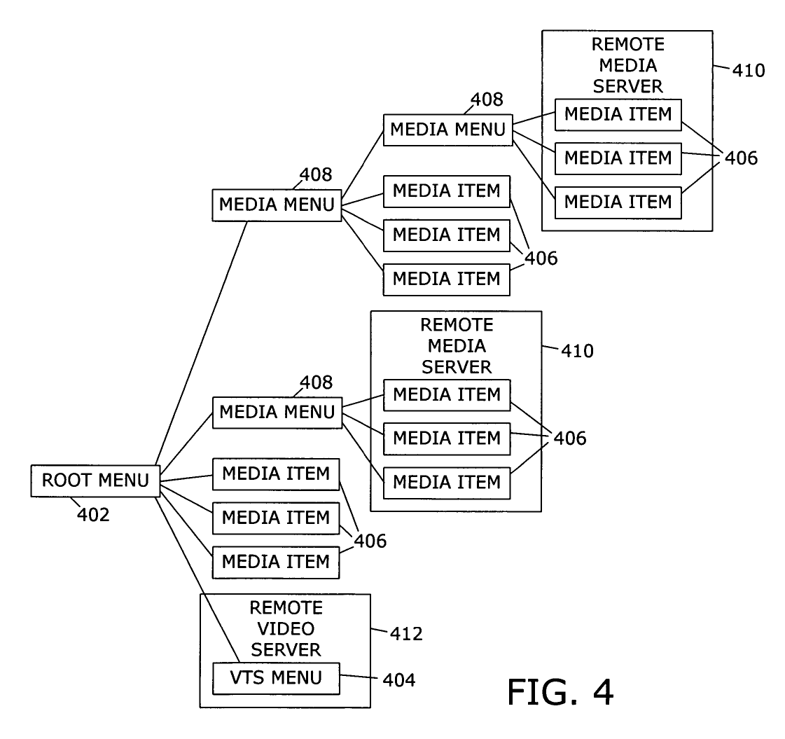

Referring to FIG. 4, a schematic block diagram illustrates an embodiment of a media tree 400 that functions as a network-distributed resource. A server analyzes media format and sources, and constructs navigation structures that enable a target device to access all distributed media, enabling dynamic control of content access—automatically without user intervention or interaction. Media is accessed as enabled according to digital rights management, encryption, and media play charge considerations. The media tree 400 extends from a root menu 402 that includes pointers to branches including a Video Title Set (VTS) menu 404, media items 406, and media menus 408. VTS menus 404, media items 406, and media menus 408 may be accessed via remote media servers 410 and a remote video server 412.

Media formats are determined by the transcoder system. For example, most formats that can be displayed by Microsoft DirectShow engine can be transcoded into a DVD MPEG video standard.

The media system addresses security operations at multiple levels. Media from one media producer is protected against alteration by another media producer. Viewing of media by some classes of users is restricted by another class of user. Viewing of digital rights management media is to be granted by the digital rights owner.

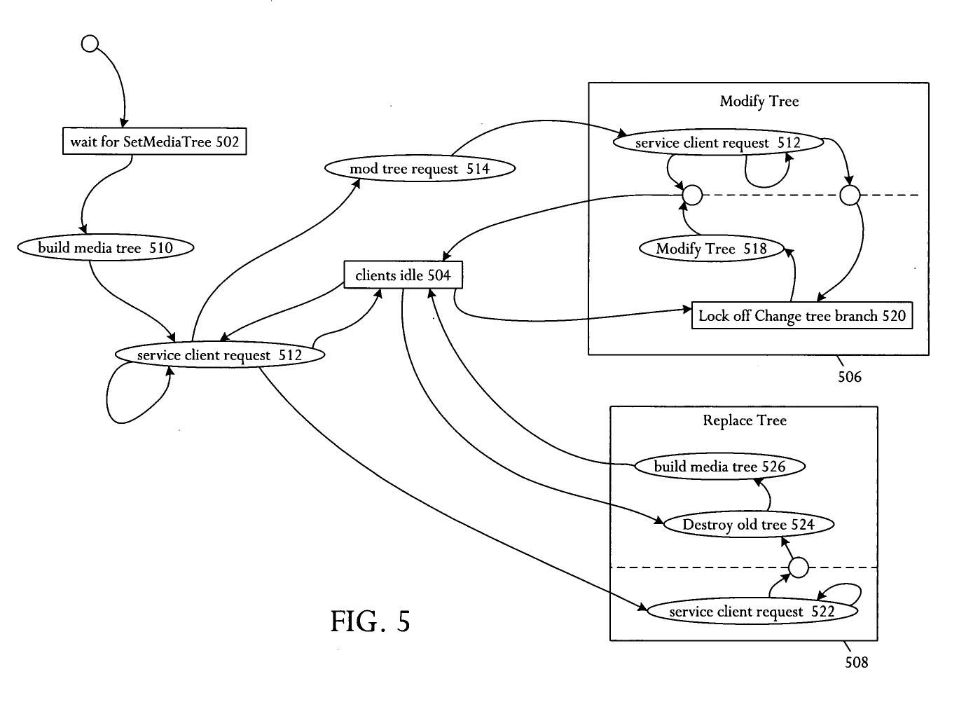

Referring to FIG. 5, a schematic state diagram depicts an embodiment of a client media server 500 such as the local media server 148 shown in FIG. 1. The dynamic volume states of the client media server 500 include a wait state 502, a clients idle state 504, a modify tree state 506, and a replace tree state 508. In the wait state 502, the client media server 500 waits for a SetMediaTree signal or flag. Upon receipt of SetMediaTree, the server builds the media tree 510, then services client requests 512. Upon receipt of a modify tree request, the server 500 services the modify tree request 514 and enters the modify tree state 506.

In the modify tree state 506 the server services client requests 516, modifies the tree 518 in accordance with client requests. In a lock-off change tree branch state 520, a tree branch to be modified is locked-off as non-affected client requests continue.

Between client requests, the server enters the clients idle state 504. A tree is replaced only after all clients go onto the idle state 504. In the modify tree state 508, the server services client requests 522, and in accordance with client requests, can destroy an old tree 524 and build a media tree 526.

Once the format of a user-supplied media file is determined, for example through examination of the file extension or the file header, other otherwise, the system intelligently assembles a mechanism that performs successful presentation of that file's media on a sink device. The mechanism may be a simple mapping, usage of an extended communication capability, transcoding, or another technique that supplies content to a sink device and enables the content to play on the device in the device native format without using a hardware or hard-coded translation device.

In some embodiments, the transcoder or transcoders in a system may be omitted and replaced by one or more decoders that that decode the content into a format compatible for presentation. One decoder implementation may use multiple client-resident decoders. Another decoder implementation uses one or more programmable client-resident decoders that may be reconfigured by downloading multiple versions of client-resident decoder code. Still other implementations may use decoder code downloaded in combination with content in which the decoder code that is appropriate for the particular content and format. Usage of downloadable decoder code enables versatile tailoring of the decoder for specific applications or content format.

For embodiments that use one or more decoders in place of the transcoders, a decoder interrogates incoming content to determine which decoder is to be used, passes the decoder identification information to the client to enable correct configuration of the decoder. The appropriate decoder generally can perform self-configuration that is transparent to the user, or pass through the appropriate decoder code which accompanies the content and informs the client with a request for the client to self-reconfigure using the supplied decoder code. Decoder implementations are less versatile than the illustrative transcoder systems because the decoder generally entails usage of client firmware and/or hardware that differs from conventional or existing client systems such as DVD players, although future clients may include programmable decoder support.

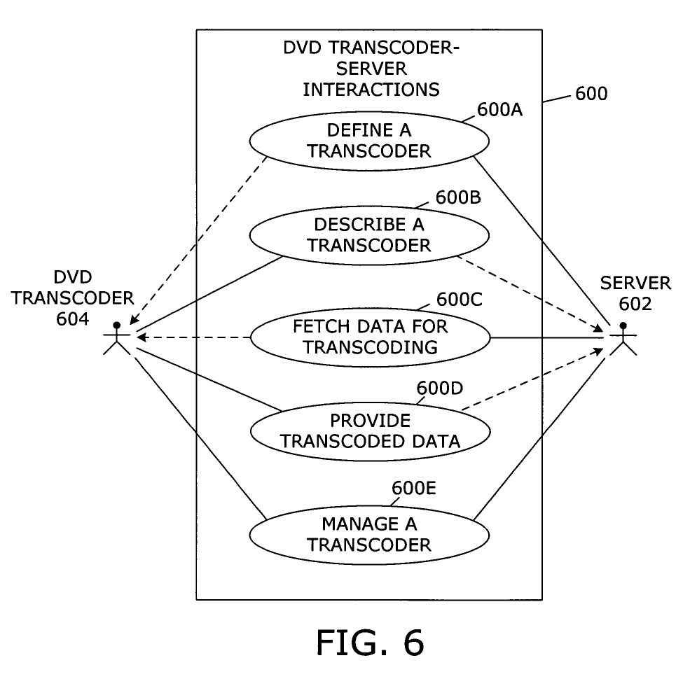

Referring to FIG. 6, a use case diagram illustrates an embodiment of a media transcoder system 600 including operations between a user device server 602 and a media transcoder 604, such as a Digital Versatile Disk (DVD) transcoder. One use case is definition 600A of a transcoding task in which the interface supplies a list of media files to the media transcoder 604. The media files are to be transcoded into a specific media Video Object (VOB) or, if appropriate, a series of VOB objects.

Use case 600B is a description of the Video Object (VOB). Information is passed from the media transcoding package to the server as a series of media-compliant information format (IFO) file content buffers. The transcoder generates one IFO for each VOB object that is generated. Transcoders generally operate under a presumption that the base address of the VOB file series is logical block address (LBA) 0 and the server manages logical block address transformations appropriate for presentation to the decoder.

A raw media file data fetching use case 600C fetches data for transcoding. The server supplies a conventional read-only block-oriented interface for the transcoder to fetch raw media data using random access handling.

A provide transcoded data use case 600D supplies a VOB data stream in real-time for the server to convey to the decoder in synchrony with data fetching. A transcoder management use case 600E supplies common resource management for the media transcoder 604 and the server 602. Transcoders are created and used in real-time on an as-needed basis. When a particular transcoding operation is complete, the transcoder is terminated and removed.

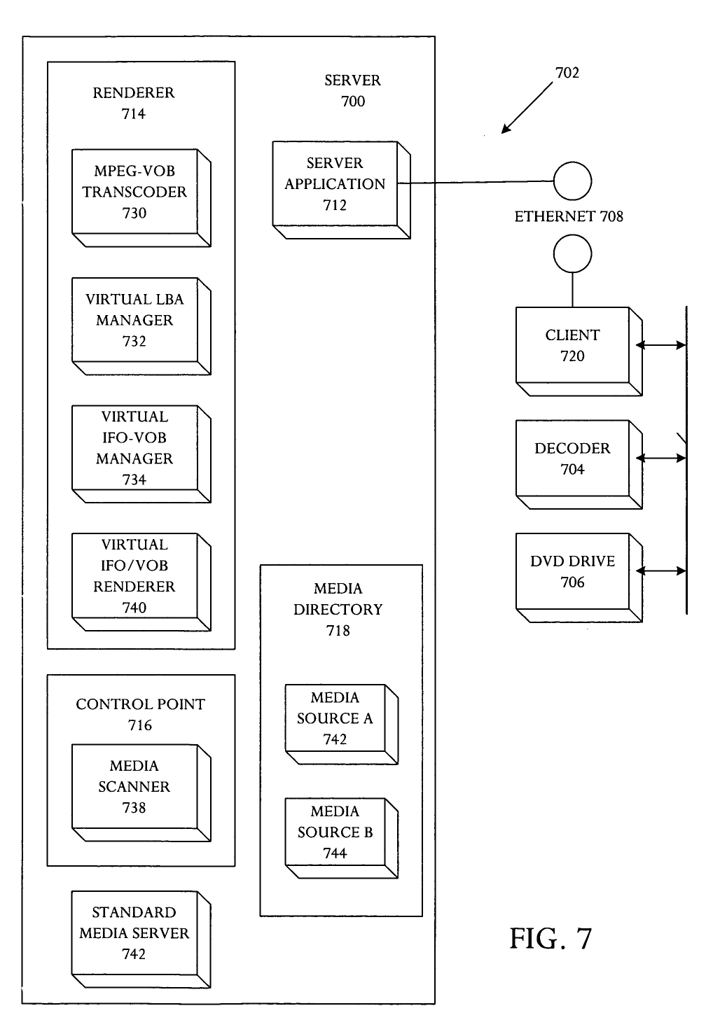

Referring to FIG. 7, a component diagram shows various system, hardware, and software components of a server 700 for usage with an emulator interface. The illustrative server 700 is capable of executing on a system 702 such as a computer, a personal computer, workstation, laptop, palmheld computer, notebook computer, or any other type of device for executing programmed code. The server 700 can communicate with one or more various information handling devices, including devices that function as a source or information or content, devices that display, perform, or render the sourced information or content, and control devices. In the illustrative example, the server 700 is configured to communicate with a client device 720, a decoder 704 such as an MPEG decoder, and a DVD drive 706 via an Ethernet connection 708. These devices are for illustration only and can be supplemented or replaced by many other types of information handling devices. The client device 720, the decoder 704, and the DVD drive 706 are each shown in a single system coupled by an IDE bus 710. In other examples, the devices may be configured in different systems and may have internal interfaces different than the IDE bus 710.

The server 700 includes one or more server applications 712 that execute in conjunction with an audio-visual (AV) system 715 and a media directory 718 to manage interactions among a variety of audio-visual devices and controllers. The server 700 communicates with the devices over the Ethernet connection 708 by operation of a server application 712, for example a software application that executes a desired content handling application. A server application 712 virtualizes media into a volume of data that is navigable by the system 715. The server application 712 can assess characteristics of source media and, if needed, modify characteristics into a more familiar form. For example, a DVD-based server 700 may change data format to appear more as a DVD disc. The server application 712 manages data streaming to one or more of multiple clients that may be connected to the server 700.

Generally, the server application 712 controls the information transfer entities and the type of processing. The server application 712 determines and selects devices that function as the content source and renderer, the type of processing performed on the content, and any control and management functionality. For example, the server application 712 can initially generate a graphical user interface display indicative of the types of content available for performance and classes of processes that can be performed on the content. A user can respond to the display by selecting the desired content and processing. The server application 712 can generate and send control signals to the selected content source and renderer that commence content accessing, transmission, rendering, and display. The server application 712 can generate and send control signals that activate devices, if any, in the path from source to renderer that process or modify the content. In some applications, the server application 712 can execute content processing routines that are suitably executed on the server processor.

The AV system 715 defines and manages general interactions among various types of audio-visual devices and supports a broad range of device configurations and applications independently of device type, content format, and data transfer protocols. For example, the AV system 715 can support an open-ended variety of audio-visual devices including, but not limited to, computers, PCs, laptops, palm-held computers, cellular telephones, workstations, video displays, electronic picture frames, televisions, CD/DVD players and jukeboxes, video cassette recorders, set-top boxes, camcorders, still-image cameras, audio systems, stereos, MP3 players. The AV system 715 can support an open-ended broad variety of content, information, and data formats including, but not limited to, Motion Pictures Expert Group (MPEG2, MPEG4), Joint Photographic Experts Group (JPEG), audio standards including MPEG-1 Audio Layer-3 (MP3), Windows Media Architecture (WMA), bitmaps (BMP), National Television Standards Committee (NTSC), Phase Alteration Line (PAL), Sequential Couleur avec Memoire (SECAM), Advanced Television Systems Committee (ATSC), video compact disk (VCD) and S-VCD standards. The AV system 715 selects and defines functionality of various content sources, content renderers, and controllers in combination with a server application 712 and the media directory 718.

The AV system 715 comprises a media renderer 714, a media controller 716, and a standard media server 742. The AV system 715 defines and manages interactions among a content source, a content renderer, and an AV interaction controller. In some embodiments, the AV system 715 can be highly flexible and compatible with any type of media source device and any type of media rendering device.

The server 700 accesses content from one or more media sources 744 and 746 from the media directory 718. The media controller 716 enables a user to locate and select content from the media directory 718 and to select a target renderer. The media renderer 714 obtains the selected content and directs transfer of the content to the selected target renderer.

In the illustrative example, the media renderer 714 includes a transcoder 730, a virtual logical block address (LBA) manager 732, a virtual content file manager 734, and a virtual content renderer 740. In one embodiment, the transcoder 730 is an MPEG to video object block (VOB) transcoder and the virtual content file manager 734 is a virtual IFO/VOB manager. The MPEG-VOB transcoder converts from an MPEG format that is commonly used to compress and display video content for computer handling to VOB files that are the standard format of DVD presentations and movies. VOB files contain multiple multiplexed audio/visual streams. The virtual IFO/VOB manager handles VOB files and information format (IFO) files containing information that describes the particular format of VOB files including playing information such as aspect ratio, subtitles, menus, languages, and the like.

The server 700 can include transcoders and virtual content file managers that transcode information in other formats depending on the particular audio-visual application. For example, a transcoder 730 can be implemented that transcodes content to and from various formats including one or more of MPEG video, Digital Video (DV), MPEG elementary (ES) or program streams (VOB), YUV4 MPEG streams, NuppelVideo file format and raw or compressed (pass-through) video frames and export modules for writing DivX, OpenDivX, DivX 4.xx or uncompressed AVI files with MPEG, AC3 (pass-through) and PCM audio. One example of a particularly useful transcoding application is transcoding of JPEG to MPEG. In another example, digital video can be transcoded to MPEG including transcoding of low quality digital video to high quality MPEG.

In an audio example, the transcoder 730 can transcode an MP3 media file to a Dolby AC3 pulse-coded modulation (PCM) format.

In a DVD player application, the transcoder 730 can transcode any transcribable media for viewing on a DVD player. For example, a power-point presentation can be transcoded to a video presentation on a DVD player.

The transcoder 730 executes decoding and encoding operations using content loading modules including import modules that feed transcode with raw video/audio streams and export modules that encode data frames. A typical transcoder 730 supports elementary video and audio frame transformations, including video frame de-interlacing or fast resizing and external filter loading. Various operations performed by the transcoder 730 include demultiplexing, extracting, and decoding of source content into raw video/audio streams for import, and probing and scanning of source content to enable post-processing of files, setting file header information, merging multiple files or splitting files for storage.

In a typical transaction, the transcoder 730 is activated by a user command and initializes content transfer, activating modules that begin transfer and buffering of audio and video streams and encoding frames. For example can initiate transfers by creating a navigation logfile that contains the frame and related group of picture list with file offsets. The transcoder 730 then executes one or more video/audio frame manipulations or simply passes through raw frame data without manipulation. Video frame manipulations may include removing an arbitrary frame region for processing, de-interlacing a video frame, enlarging or reduction of video width or height, filtering for image resizing, removing an arbitrary frame region for encoding, and downsampling of video width/height. Other video manipulations may include video frame flipping or mirror imaging, gamma correction, anti-aliasing, or color manipulations. Audio frame manipulations may include volume changes, audio stream resampling, and synchronizing video and audio frames.

The transcoder 730 can load export modules for audio/video encoding and begin an encoder loop operation that started for the selected frames.

The virtual LBA manager 732 controls definition and accessing of virtual logical block addresses in the media and relates the virtual logical block addresses to physical storage addresses of the media. By creating virtual logical block addressing, the virtual LBA manager 732 manages dynamic access of content from a variety of different content sources in the manner of a particular physical source. In this manner, the virtual LBA manager 732 enables a first device, for example a nonstandard or nontypical device, to emulate a second device, for example a device that normally supplies content within a system, using logical block addressing. In a particular example, the virtual LBA manager 732 can emulate addressing of DVD player content from content acquired from the Internet.

The virtual content manager 734 operates in conjunction with the virtual LBA manager 732 to dictate a map of physical addresses to virtual block addresses. The virtual content manager 734 tracks all elements of content data and maintains links among associated data including local data links and remote data links. Storage on the server 700 is in the configuration of multiple linked lists among files that reference one another. The virtual content manager 734 maintains links among files, identifying and positioning on one or more media volumes. The virtual content manager 734 verifies and ensures that the IFO file references are maintained to assure consistency of references at a directory and volume management level.

The virtual content manager 734 functions to handle storage and accessing of media content in the manner that a virtual memory manager operates in a computer. A virtual memory manager tracks chunks of memory. The virtual content manager 734 tracks chunks of media. The virtual content manager 734 enables multiple chunks of media to be stored with overlapping addressing.

The virtual content manager 734 receives commands from the media controller 716 that initiate or modify accessing and presentation of content. The virtual content manager 734 responds by determining the format of IFO and VOB files and activating the virtual LBA manager 732 and transcoder 730, if needed, to begin media streaming. The virtual content manager 734 also functions in conjunction with the virtual content renderer 740 to perform media rendering.

The virtual content renderer 740 operates on media files to format media to meet the functionality and capabilities of a presentation device, such as a DVD player.

In an illustrative embodiment, the virtual content renderer 740 is a virtual IFO/VOB renderer. The virtual content renderer 740 manipulates content data according to directions by the virtual content manager 734 to render content. The virtual content renderer 740 manipulates content data elements, supplying information to files identified and located by the virtual content manager 734. The virtual content renderer 740 also creates IFO files for media that do not already have IFO files including creation of selection trees that appear as cascading menus. IFO files are used to play various files including presentation of menus. Menus are a selection presentation for clusters of media. The virtual media renderer 740 can generate multiple menus in a tree structure until all media is accessible. The virtual content renderer 740 creates IFO files as a manifestation of a play list structure.

Other examples of media that do not have IFO files are MPEG from digital video or other a myriad of other sources such as power point data for slide shows. In some applications, the virtual content renderer 740 adds content that would not exist without rendering for presentation. For example, the virtual content renderer 740 can configure JPEG images and add filling content to create a slide show of MPEG images to generate slide-show functionality. The illustrative media controller 716 includes a media scanner 738. In an illustrative embodiment, the media controller 716 allows monitoring of how the media is evolving through operation of the media scanner 738.

The media scanner 738 tracks the media directory 718, enabling media content and the media directory 718 to be mutable. The media scanner 738 regularly accesses the media directory 718 to determine whether any changes in the content of the media directory 718 have occurred and changing virtual structures in the media renderer 714 and the server application 712 to track changes in the media. The media scanner 738 monitors for changes and responds to any changes by updating virtual structures.

The standard media server 742 can access a variety of content, either locally stored or stored on an external device. The standard media server 742 is capable of accessing content and transferring the accessed content to another device via a network using a standard transfer protocol, for example HTTP or FTP. The standard media server 742 can locate content available on a network from a variety of devices and communicates with the media controller 716 to enable browsing or searching for available content items. The standard media server 742 typically includes a content directory, a connection manager, and a transporter. The content directory includes functions that interact with the media controller 716 to search or browse for content, supplying information and properties that specifically identify the content. The connection manager manages connections associated with a particular device including preparation for content transfer, issue of flow control commands, distinguishing of multiple instances to support multiple renderers, and terminating connections when a transfer is complete. The transporter can be used to operate in conjunction with the media controller 716 to control content flow. The standard media server 742 can supply media that does not require large changes for accessibility by conventional rendering hardware.

The media directory 718 is a media container, holding a list of all available media content and possibly some or all of the media content. The media directory 718 operates as a virtual media directory, enabling and facilitating access to locally-stored media content and remote media contained by other servers and devices. The media directory 718 stores Uniform Resource Identifiers (URIs) that identify content resources. URIs includes WWW addresses, Universal Document Identifiers, Universal Resource Identifiers, and combinations of Uniform Resource Locators (URL) and Names (URN). Uniform Resource Identifiers are formatted strings that identify a resource by name, location, or another characteristic. The media directory 718 holds URIs of all files that the server 700 can deliver for rendering. The URIs can correspond to files stored anywhere.

The media directory 718 identifies available content sources, for example media sources 744 and 746, and contains directory information to facilitate acquisition of content from one or more of the media sources.

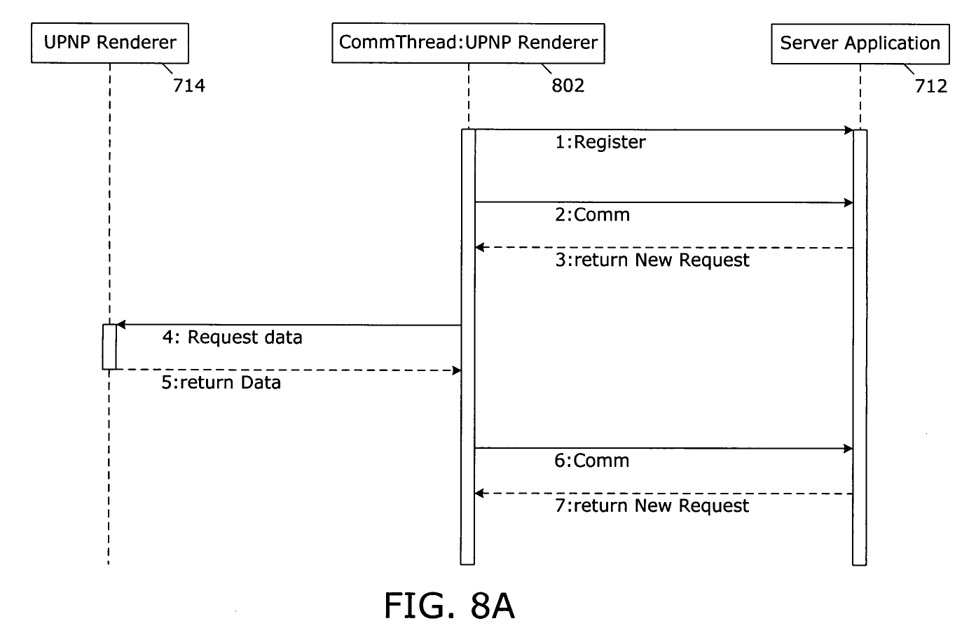

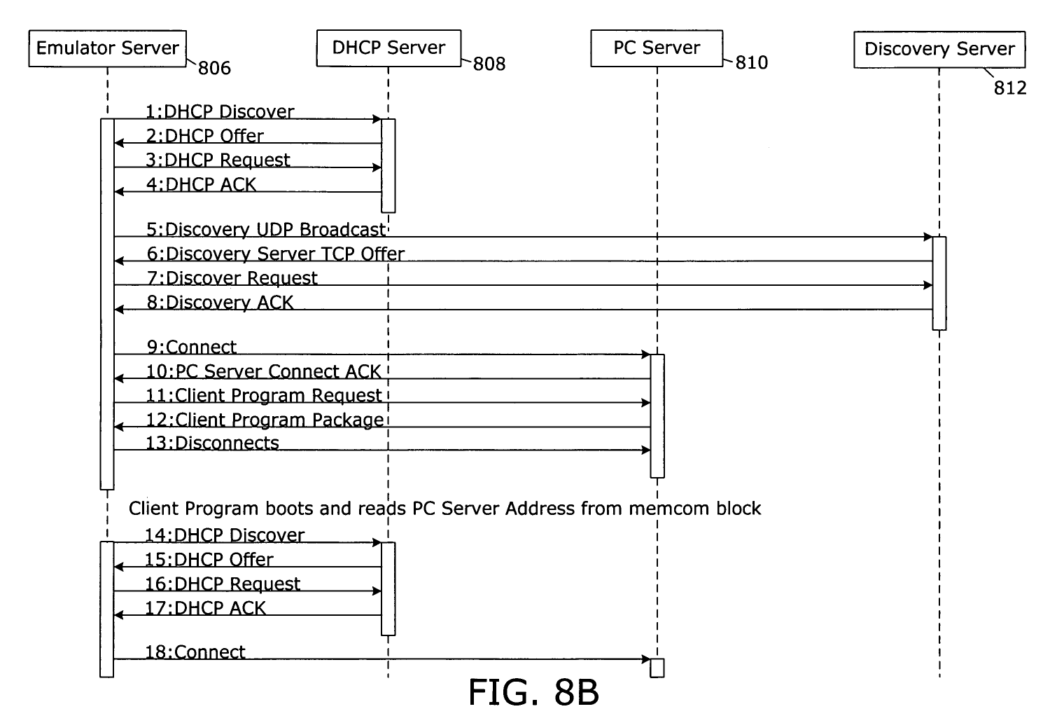

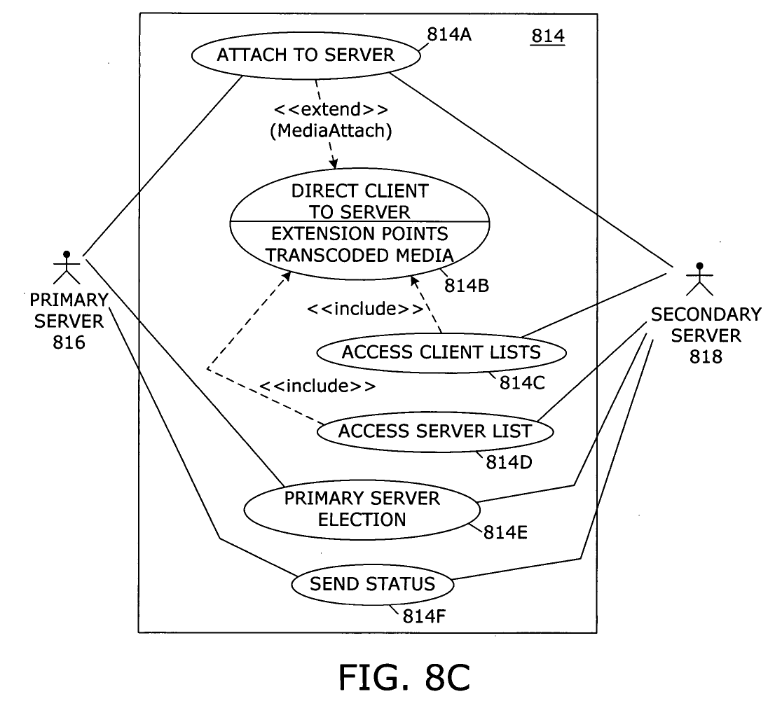

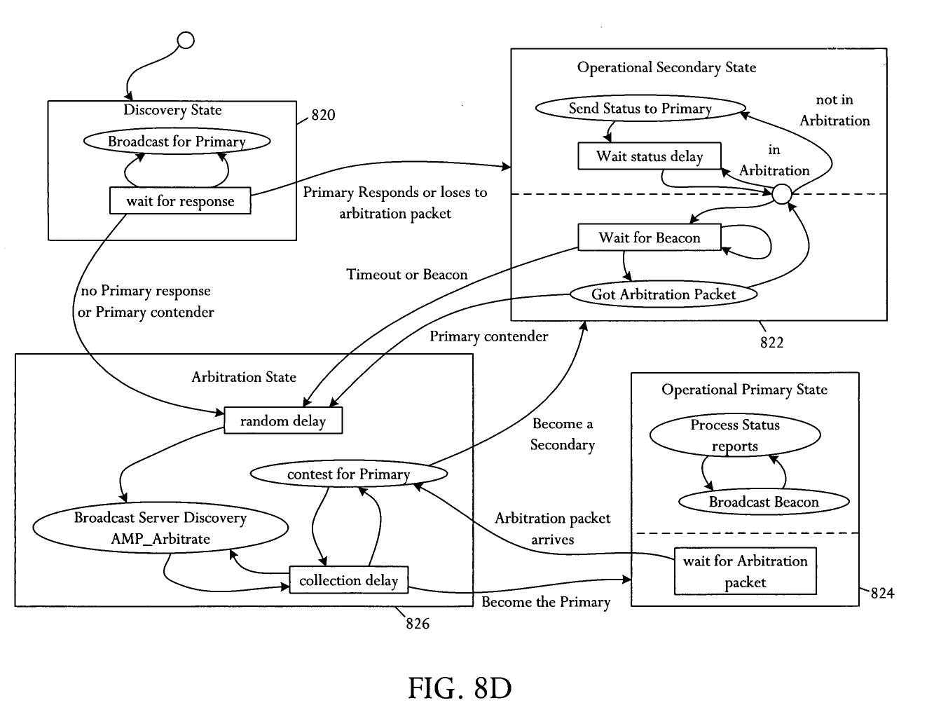

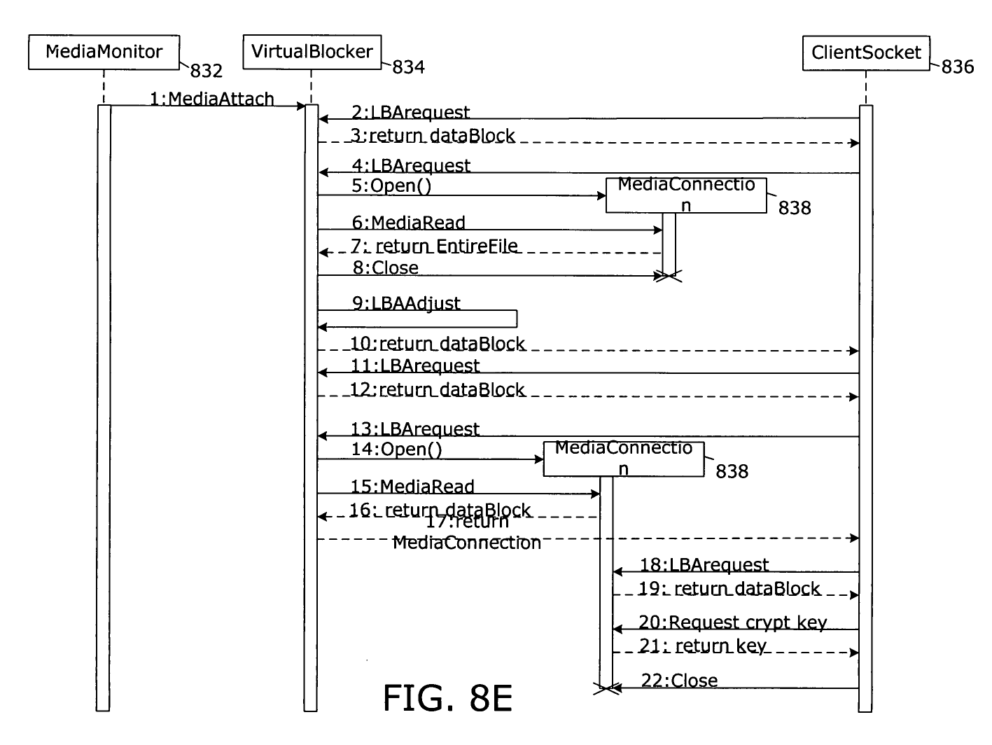

Referring to FIG. 8A, a timing diagram illustrates interactions 800 between the renderer 714 and server application 712 via a communication thread 802. In the illustrative embodiment, a dynamic link library (DLL) MaestroLink Netcoms communication calls a process:
bool MaestoLinkRegister(void);

A Noop returns true when a connection is made and ready to begin requesting: bool MaestroLinkComm(unsigned int *Iba, unsigned int *count, *unsigned char *data, unsigned int count).

The call supplies data to MaestroLink and collects the next request in one operation. For the first call to MaestroLink, the dlength is zero and the data pointer is NULL. MaestroLink supplies the request at the designated pointers. Once the data is available, MaestroLinkComm is called again and the data now is valid. A return is not made until MaestroLinkComm has obtained the next dat request. To enable cross-checking, the logical block address and count are only changed by the MaestroLinkComms download link library.

Referring to FIG. 8B, a timing diagram illustrates interactions 804 between a user device 806, a Dynamic Host Configuration Protocol (DHCP) server 808, a server application 810, and a discovery server 812.

FIG. 8C is a schematic use case diagram 814 for server coordination interactions between a primary server 816 and a secondary server 818. The Server Discovery protocol enables coordination and orderly operation of the servers on a network segment. A network segment contains one or more servers and zero or more clients and/or Server Console Windows. A paradigm of the primary server 816 and zero or more secondary servers 818 enables a single entry point for clients requesting media trees. The Server Logging Console supplies a window-based user interface for controlling and monitoring any server on the network. The Console Server enables access to server and client Internet Protocol (IP) addresses, for example the IP address and possibly machine names of the server running on a local device can be shown in a Title Bar, and a list of server and client IP addresses and associated machine names can be maintained by the server and displayed in the Server Console Window. Server functions are available for modification in the Server Console Window via a Tools menu. Logging configuration can be displayed and controlled by a logging control checkbox. Log history size, logging of internal errors and actions, and other functions can be accessed via an Options menu.

The state diagram depicted in FIG. 8D illustrates the Server Discover protocol in operation. The Server Discovery protocol enables orderly operation of multiple servers on a network segment. A network segment contains one or more servers and zero or more clients and/or Server Console Windows. The primary server and zero or more secondary servers create a single entry point for clients requesting media trees. Multiple distinct states are defined as part of the protocol. The protocol defines the states, operation in the states, and packets specific to each state. The defined states are Discovery 820, Operational 822 and 824, and Arbitration 826. In an illustrative embodiment, the protocol uses ZMP_ServerDiscovery operation codes and enables usage of ZMP_Request, ZMP_Reply, ZMP_Status, ZMP_StatusRequest, ZMP_StatusREply, ZMP_Arbitrate, and ZMP_Beacon sub-codes.

In a Discovery state 820, a server attempts to locate the current Primary Server on the network segment. The server locates the current Primary Server on the network segment by broadcasting a ZMP_ServerDiscovery/ZMP_Request. If a ZMP_ServerDiscovery/ZMP_Reply response is received, that Primary Server IP address is retained for future use and the server transitions to Operational Secondary State 822. If no Primary Server response is received after a number of attempts to locate a Primary Server before transitioning fro Discovery State 820 to Arbitration state 826 called SERVER_DISCOVERY_SERVER_LOCATE_MAX_TRYS attempts spaced by a set time to wait for a response to an individual ZMP_ServerDiscovery/ZMP_Request called a SERVER_DISCOVERY_SERVER_TIMEOUT_MILLISECONDS time, Arbitration state 826 is entered. The current Primary Server is to respond with a ZMP_ServerDiscovery/ZMP_Reply packet with the list of servers as a payload. A Server Console Window may also broadcast a ZMP_ServerDiscovery/ZMP_Request to enable location of the Primary Server and receive a list of all servers. The ServerConsoleWindow can use a back-off retry policy.

In the operational states, the Primary Server maintains a list of Secondary Servers and supplies the list via a ZMP_ServerDiscovery/ZMP_Beacon and ZMP_ServeDiscovery/ZMP_Reply packets. A unicast reply packet is sent in response to a ZMP_ServerDiscovery/ZMP_Request, while a broadcast beacon is sent at a time between ZMP_ServerDiscovery/ZMP_Beacon packets sent by the Primary Server called SERVER_DISCOVERY_BEACON_PERIOD_MILLISECONDS time intervals. The Secondary Servers are responsible for monitoring the Primary Server and re-arbitrating if the Primary Server is declared absent. A Secondary Server also informs the Primary Server of the monitored status. All servers watch for arbitration packets. If a server receives an arbitration packet, the receiving server transitions to the Arbitration state 826. In an Operational Primary State 822, a list of servers is maintained by the Primary Server by noting which servers have sent ZMP_ServerDiscovery/ZMP_Status packets recently. A particular server that has issued no packets in SERVER_DISCOVERY_SECONDARY_MISSING_MILLISECONDS is removed from the server list. A list of servers is supplied by the Primary Server via usage of a ZMP_ServerDiscovery/ZMP_Beacon packet sent every SERVER_DISCOVERY_BEACON_PERIOD_MILLISECONDS. The beacon packet contains the list of servers. In an Operational Secondary State 824, a Secondary Server maintains information in the Primary Server of status for inclusion of the Secondary Server in the Primary Server's list of servers. The Secondary Server maintains status by sending regular unsolicited ZMP_ServerDiscovery/ZMP_Status unicase packets to the Primary Server. If the Secondary Server does not receive a ZMP_ServerDiscovery/ZMP_Beacon packet from the Primary Server within SERVER_DISCOVERY_PRIMARY_MISSING_MILLISECONDS, then the Secondary Server transitions to the Arbitrate state 826. If a Secondary Server receives a ZMP_Discovery/AMP_Arbitrate packet, the Secondary Server transitions to the Arbitrate state 826 unless the Server's priority is lower than the received arbitration packet.

A Server Console Window may use either the broadcast of unicast version of ZMP_ServerDiscovery/ZMP_Request to obtain a list of servers from the Primary Server. If the Primary Server is known, typically the unicast version is used in preference to the multicast broadcast. If the Primary Server is not located via unicast, the Server Console Window enters fallback to broadcast requests in case the saved Primary Server IP address is state.

The Arbitration State 826 votes for the Primary Server. The Arbitration State 826 is entered when no Primary Server is detected by any Secondary Server on the network segment or when any server has received a ZMP_ServerDiscovery/ZMP_Arbitrate packet. In the Arbitrate state 826, all servers commence sending broadcast ZMP_ServerDiscovery/ZMP_Arbitrate packets if the servers remain contenders for the server list. If a received arbitration packet indicates that a particular secondary server in Operational Secondary state would lose arbitration, then the server is maintained in the Operational Secondary state. All servers except the current Primary Server waits a small random-length delay from detection of the first arbitration packet before sending a responding first arbitration packet, thereby limiting collisions by network responders. A “last one standing” algorithm is used to determine an arbitration winner. Each time a server receives a ZMP_ServerDiscovery/ZMP_Arbitrate packet, the receiving server continues to compete for Primary Server status. Possible rules and priorities are: a command-line configured as Primary wins, shortest tree wins, and lowest MAC address wins. A server that is not informed that another server has highest priority continues to send arbitration packets, otherwise the server transitions to Operational Secondary state 822. The server resumes sending ZMP_ServerDiscovery/ZMP_Status packets upon receipt of a ZMP_ServerDiscovery/ZMP_Beacon packet. If the server does not receive a packet from the Primary Server within SERVER_DISCOVERY_PRIMARY_MISSING_MILLISECONDS, the Secondary Server transitions to the Arbitration State 826. The winner detects success by noting that SERVER_DISCOVERY_ARBITRATE_MAX_TRYS uncontested ZMP_ServerDiscovery/ZMP_Arbitrate packets spaced by SERVER_DISCOVERY_ARBITRATE_PERIOD_MILLISECONDS have been sent by the winner. The winner announces success by transitioning to the Operational Primary State 824 and sending a ZMP_ServerDiscovery/ZMP_Beacon packet.

Server Discovery Protocol defines the content of network packets and the context of usage. Some packets including ZMP_ServerDiscovery/ZMP_StatusRequest and ZMP ServerDiscovery/ZMP_StatusReply describe individual server status, carrying a payload of ZMPDiscoverServerStatus. The destination of the packet is set by ZMP_ServerDiscovery/ZMP_StatustoPrimaryServer and ZMP_ServerDiscovery/ZMP_Status ReplytoRequestor. Every SERVER_DISCOVERY_STATUS_PERIOD_MILLISECONDS, each Secondary Serer sends unsolicited unicast ZMP_ServerDiscovery/ZMP_Status packets to the Primary Server. The packets are collected and organized into a list of servers and clients by the Primary Server. Every server, either primary or secondary, responds to a ZMP_ServerDiscovery/ZMP_StatusRequest with a ZMP_ServerDiscovery/ZMP_StatusReply. The payload includes a ZMPDiscoverServerStatus object containing the server's IP, Flags (currently zero), load factor (100×LoadFactor/MaxLoadFactor=percentage load), a count of clients and a list of zero or more client IP addresses.

```
typedef struct ZMPDiscoveryServerStatus_s {
  Unsigned int ServerIP;
  unsigned short Flags;
  unsigned short MaxLoadFactor;
  unsigned short LoadFactor;
  unsigned short Clients;
  Unsigned int ClientIP[ ];
} ZMPDiscoveryServerStatus;
```

Server status is requested by issuing a ZMP_ServerDiscovery/ZMP_StatusRequest packet to a destination that is either the Primary Server or a Secondary Server. The packet is issued to elicit individual server status. A Primary or Secondary Server will respond to ZMP_ServerDiscovery/ZMP_StatusRequest with a ZMP_ServerDiscovery/ZMP_StatusReply.

Server discovery is requested using a ZMP_ServerDiscovery/ZMP_Request packet directed to a destination such as a broadcast MAC and IP or unicast if the Primary Server is known. A new Secondary Server or Server Console Window, when coming on line, begins broadcasting requests to locate the Primary Server. A Server Console Window repeatedly sends the request until the reply is received. A Secondary Server ceases sending requests upon receiving the reply or by beginning arbitration. When operating as a Secondary Server, if no response is received from the Primary Server after SERVER_DISCOVERY_SERVER_LOCATE_MAX_TRYS attempts to send ZMP_ServerDiscovery/ZMP_Request and waiting SERVER_DISCOVERY_SERVER_TIMEOUT_MILLISECONDS, the Secondary Server presumes no Primary Server exists and enters the Arbitration state 826. If sending unicast, after the first unanswered request, remaining requests are broadcast.

The Primary Server sends a beacon as broadcast MAC or IP using a ZMP_ServerDiscovery/ZMP_Beacon packet with a ZMPDiscoveryServerBeach payload that specifies a servers list. The Primary Server sends the broadcast beacon every SERVER_DISCOVERY_BEACON_PERIOD_MILLISECONDS to prevent Secondary Servers from arbitrating. The ZMP_ServerDiscovery/ZMP_Beacon payload includes the Server's IP, a Flags word that is currently zero, and a count of Secondary Servers and zero or more Secondary Server IPs. The payload can have the following format:

```
typedef struct ZMPDiscoveryServerBeacon_s {
  Unsigned int ServerIP;
  unsigned short Flags;
  unsigned short SecondaryServers;
  Unsigned int SecondaryServerIP[ ];
} ZMPDiscoveryServerBeacon;
```

The reply from the Primary Server beacon is in the form of a ZMP_ServerDiscovery/ZMP_Reply packet with a ZMPDiscoveryServerAggregateStatus payload. The destination is a reply to specific MAC and IP addresses. The reply is returned unicast to the requestor in response to the ZMP_ServerDiscovery/ZMP_Request, a request that can be unicast or broadcast. The ZMPDiscoveryServerAggregateStatus payload includes a Server IP, 16-bit Flags word that is currently zero, and a count followed by one ore more ZMPDiscoveryServerStatus structures. The first structure is used for the Primary Server. The payload can have a form as follows:

```
typedef struct ZMPDiscoveryServerAggregateStatus_s {
  Unsigned int ServerIP;
  unsigned short Flags;
  unsigned short Servers;
  ZMPDiscoveryServerStatus; Status[ ];
} ZMPDiscoveryServerAggregateStatus;
```

To arbitrate for status as Primary Server, a contender sends ZMP_ServerDiscovery/ZMP_Arbitrate packets to a destination via broadcast MAC and IP with a payload including MediaTreeLength and CommandLineConfiguration. To win arbitration, a contender is to win SERVER_DISCOVERY_ARBITRATE_COUNT uncontested arbitration cycles. Each cycle includes broadcasting of a ZMP_ServerDiscovery/ZMP_Arbitrate packet followed by SERVER_DISCOVERY_ARBITRATE_PERIOD_MILLISECONDS collection period to monitor and evaluate responses. If the contender's arbitration priority is less than that of a response, the contender transitions to Operational Secondary State 822. After winning arbitration, a server transitions to Operational Primary State 824 and begins sending ZMP_ServerDiscovery/ZMP_Beacon packets, indicating winning of the arbitration. An example of the ZMP_ServerDiscovery/ZMP_Arbitrate packet follows:

```
typedef struct ZMPDiscoveryServerArbitrate_s {
  Unsigned int ServerIP;
  unsigned short Flags;
  unsigned short ArbitrationCount;
  Unsigned int MediaTreeLength;
  Unsigned int CommandLineConfiguration;
} ZMPDiscoveryServerArbitrate;
```

Referring to FIG. 8E, a timing diagram illustrates a media server 830 in interactions between a MediaMonitor 832, a VirtualBlocker 834, and a ClientSocket 836. Media Attach supplies a list of all files in the volume. In a first pass, the file list is restricted to be a copy of an existing TS_VIDEO directory. All files are already mutually coherent during the first pass. The Media List contains an array of structures, each structure describing the name and length in bytes of the file in the media directory. LBArequest (2) makes a volume data request that results in a returned dataBlock (3). LBArequest (4) makes an IFO File Request, that is executed by Open (5), MediaRead (6), returnEntireFile (7), and Close (8). LBArequest (13) makes a VOB File Request, that is executed by Open (14), MediaRead (15), returnDataBlock (16), and return MediaConnection (17). VOB DataClose occurs when the MediaConnection no longer has data to communicate. If data is encrypted, the media reader supplies the key via Request crypt key (20) and return key (21).

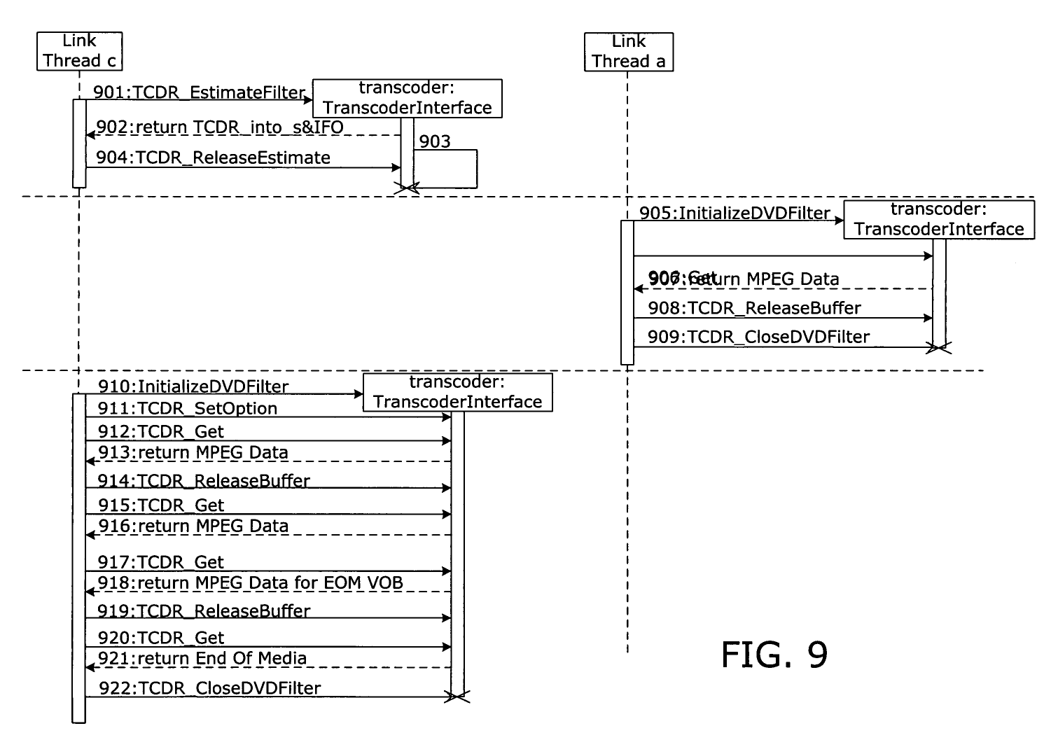

Referring to FIG. 9, a schematic sequence diagram illustrates an embodiment of an interaction between a server and a media transcoder. Transcoders are transient objects that perform a designated function when requested and either go dormant using a minimum amount of system resource or are completely destroyed at the end of the task. All calls to the transcoder may be performed concurrently so that the transcoder is responsible for multiple-thread protection of critical code areas. A transcoder may be deleted while in any state to carefully attend to resource release at deletion.

In an illustrative embodiment, a transcoder is referenced by a single immutable integer entity by the interface system. The entity is a unique token that is passed to the interface routines to distinguish multiple created transcoders from one another.

The transcoder has two distinct functions. A first function is to survey a task and produce a parametric on the resulting MPEG object. A second function is to perform transcoding of the given media objects into an MPEG data stream. All object input/output operations for the tasks are performed through the input/output system.

Upon creation, a transcoder receives a list of User Identifiers (UIDs) that may be any mix of media objects. The transcoder also receives an enumerated value designating a requested target format, for example an MPEG format. The transcoder library can recognize and transcode media objects, for example including single frames, audio, audio in combination with a single frame, and video objects. A single frame is any series of static graphic objects to be converted to a target format such as into an MPEG slide show. The transcoder performs bitmap size, pixel size, and color depth conversion for an optimum display of a given object. Audio data is any series of audio objects to be converted into an MPEG audio file with a single default video slide presented throughout the media experience. Chapter stops are set on every object border. Audio and single frame data are presented to the transcoder as an audio object followed by a series of single frame objects. The transcoder produces an MPEG stream in which the single frame objects transition evenly through the audio object play time. Chapter stops are set on the audio object transition points. The transcoder produces a best fit target stream, such as the MPEG stream, for presented Video objects. In the case of a video frame that is too small to be converted to a minimum MPEG resolution, transcoded data may include black bordered in the stream with mild zoom. The specific media source objects and formats are iterated in the deliverable time table. The time table also dictates the MPEG formats time of delivery.

Upon creation, the transcoder users interface-supplied input/output routines to survey a file list. The transcoder produces an IFO file structure that the system uses to construct a media delivery system. The IFO file descriptor of the resulting media data stream may be slightly larger than the actual resulting stream with the extra size included at the end of the entire stream. Even if the resulting stream creates multiple 1 gigabyte VOB segments, all IFO specified excess space is appended to the logical end of the stream. Most of the IFO includes non-essential content including boilerplate, stream descriptors, and the like, however a play list enables proper functioning of the system. The transcoder IFO structure data includes a first transcoded VOB object that begins at logical address 0 and each subsequent VOB is contained in the same contiguous logical address space. The transcoder estimates the size of the media stream in some cases and the estimate is always larger than the actual size but within 10% of the overall actual size.

In an illustrative embodiment, IFO file structures supplied in a transcoder survey include VTSI_MAT, PTT_PRTI, VTS_PGCITI, VTSM_PGCI_UT, VTS_TMAPTI, VTSM_C_ADT, VTSM_VOBU_ADMAP, VTS_C_ADT, and VTS_VOBU_ADMAP. VTSI MAT is the main-IFO table and is essentially included in each IFO file. VTSI_MAT table specifies the contained video and audio streams in the VOB file. The video stream can be specified as compressed video such as MPEG1 or MPEG2, television video such as (National Television System Committee) NTSC or Phase Alternation Line (PAL). Other values in VTSI_MAT table specify aspect ratio, display mode such as letterboxed, bit rate (Variable (VBR) or constant (CBR)), and resolution.

PTT_PRTI is a chapter table that is essential if the content contains a movie. A chapter table, if included, specifies at least one chapter and contains a chapter number 1. A chapter specified by PTT_PRTI links to a program in a PGC in the table.

VTS_PGCITI is a main program chain that handles media playback. The Program Group Control (PGC) has at least one program, which links to the first cell in the PGC. Accordingly, at least one cell is contained in the PGC and holds the start sector in the VOB file of the cell, the playback time, and the end sector of the cell.

Video title set file structures including VTSM_PGCI_UT, VTS_TMAPTI, VTSM_C_ADT, and VTSM_VOBU_ADMAP are nonessential structures. VTS_C_ADT holds a list of all cells within the VOB file. Cell values contain start and end sector addresses within the VOB file. VTS_VOBU_ADMAP is a table that holds a list of all VOB units inside the VOB file, and contains the start sector of each VOB unit inside the VOB file.

Once the survey function is completed, the transcoder enters a dormant state until the interface executes a GET function to draw some of the media stream, for example an MPEG stream, from the transcoder. The media stream fetches are random access at an address based upon an initial zero address of the VOB object. Every fetch has a starting logical block address (LBA) which is offset into the media stream of 2048 data blocks.

Once a GET request is made by the transcoder, the transcoder uses either the user device-supplied input/output interface or a media graph functionality (for example From Microsoft Corporation of Redmond, Wash.) to fetch the appropriate media data. The input/output routines are asynchronous and do not return unless the input/output operation is complete or an error condition occurs. The transcoder then transcodes the received portion into a transcoder-managed input/output buffer. The number of 2048 byte blocks transcoded by a single GET call are determined by the transcoder and affected by the constructed media graph and the domain within which the graph operates. The domain may be defined in terms of time or number of bytes transcoded. The stream is restricted to any number of 2048 byte blocks within a predetermined maximum. In an illustrative embodiment, the capacity is set to 512 kilobytes. The GET routine enables the transcoder to set the number of 2048 byte blocks that are returned in the buffer.

The buffer is passed as immutable to the user device for stream delivery. The user device later performs a separate call to the transcoder to release the buffer back into the transcoder's buffer pool. The user device may register multiple GETs from multiple threads on the transcoder. The multiple GETs may not be serialized because the logical block addresses may not be requested in order of delivery. Suspends may occur only during the input/output operation.

The user device views the function of transcoding as an inherently stateless process. A specific piece of the media stream is requested and that portion is returned. A next request does not necessarily relate to any other request. The transcoder accordingly simply remains idle awaiting a stream request. If the transcoder is deleted during any request or set of requests, the transcoder retrieves all active GETs with an error indication, waits for outstanding input/output, and then organizes resources.

The sequence diagram in FIG. 9 shows the server-transcoder iteration. Beginning at an interaction 901, an estimation process is documented in which a transcoder is constructed to supply an information hallway with a TCDR_info structure to hasten future instantiations of the transcoder with the same media file. Interactions 906 through 908 may repeat many times. Many files may be open and remain open during the transcoder lifetime. In one embodiment, Microsoft transcoder graphs may be used to directly access local files. The illustrative example demonstrates a set of transcoder interactions using a set EndOfMediaVOB option. The option is set before the first GET is called. Interactions 912 through 914 repeat until the media is exhausted. At the end of media no buffer is returned and an end-of-media return is made. A user thread then may continue to fetch the EndOfMediaVOB, possibly using multiple TCDR_GETs. The buffer is released each instance, but the transcoder need not copy the VOB information from the source buffer on the SetOption call, since the data is assured to be constant. For each EndOfMediaVOB, a EndOfMedia return is made with an empty buffer. The sequence may continue until a CloseDVDFilter call is made.

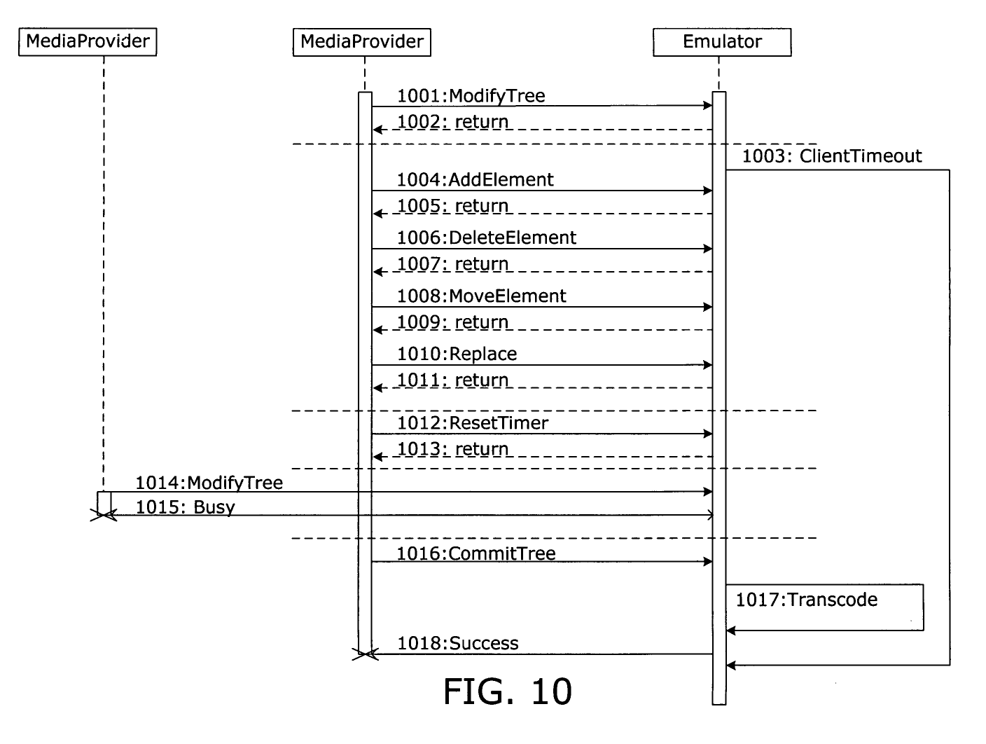

Referring to FIG. 10, a sequence diagram illustrates interactions of a Simple Object Access Protocol (SOAP) media definition server that supports media tree modification. ClientTimeout (3) is supplied in case a client does not reset the timer. Any number of messages, for example shown as AddElement (4), DeleteElement (6), MoveElement (8), and Replace (10) may occur in any order and may be grouped in any number of (SOAP) envelopes. ResetTimer (12) is inserted since the timer is to be reset at specified intervals, or ModifyTree will end. CommitTree (16) denies other requests during ModifyTree. Timer messages are not used after commit and receive a fault return.

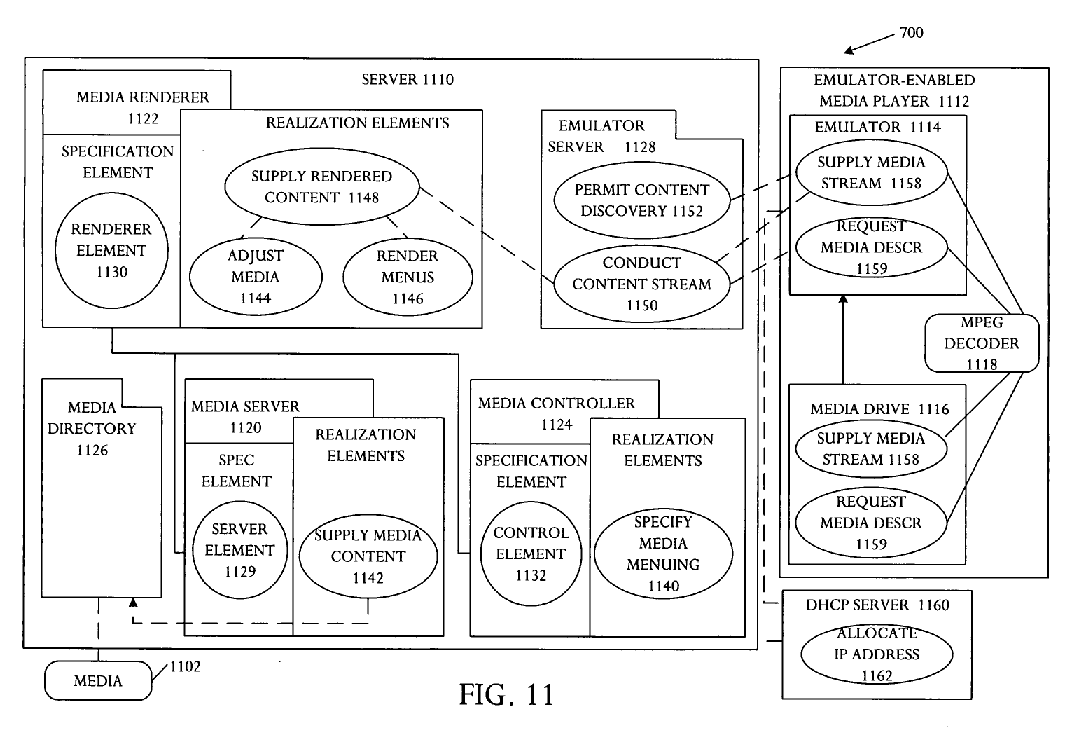

Referring to FIG. 11, a use case diagram illustrates functionality of an audio-visual system that uses an emulator interface. The audio-visual system 1100 includes a server 1110 that is capable of executing on a processor and an emulator-enabled media player 1112. The server 1110 manages accessing and streaming of content to the emulator-enabled media player 1112. The emulator-enabled media player 1112 receives content from the server 1110 and performs or presents the content. In a particular embodiment, the audio-visual system 1100 can be a video system that plays video content from one or more sources on an emulator-enabled DVD player.

The server 1110 has several functional blocks including a media server 1120, a media renderer 1122, a media controller 1124, a media directory 1126, and an emulator server 1128. The media server 1120, the media renderer 1122, and the media controller 1124 contain specification elements, respectively a server element 1129, a renderer element 1130, and a control element 1132. The specification elements comply with standard communication protocols.

The media controller 1124 and the media renderer 1122 include specialized control operations and rendering operations, respectively. For example, the media controller 1124 includes control functionality to select, enable, initiate and manage emulated interactions. The media renderer 1122 includes a specialized renderer that is a proxy for the emulator network communications server 1128. The media controller 1124 communicates with the media server 1120 and the media renderer 1122 to initialize a source to supply content, set content transfer parameters, and begin content delivery. Media structure requests are sent to the media controller 1124, and the media controller 1124 sends control signals causing the media server 1120 to transmit media files to the media renderer 1122 including functional elements in the media renderer 1122 that activate the emulator media stream.

The media controller 1124, which may be termed a control point, examines the media directory 1126, and specifies media menuing 1140, for example DVD menuing, creating menus in the media directory 1126 concurrently with content transfer. The media directory 1126 contains some or all media content along with a list of available content for producing and displaying menus. A media provider 1002 makes media available to the media directory 1126.

The media server 1120 receives control signals from the media controller 1124 and responds by supplying media content 1142 for rendering. The media renderer 1122 receives the control signals and adjusts the media to the emulated standard 1144. The media renderer 1122 can render media player menus 1146 for presentation of the menu by the emulator-enabled media player 1112. The media renderer 1122 receives and renders the content, supplying the rendered content 1148 to the emulator server 1128.

The emulator server 1128 functions as an interface between the media renderer 1122 and the emulator-enabled media player 1112. The emulator server 1128 conducts the media content stream 1050 from the media renderer 1122 to the emulator-enabled media player 1112 and receives control information from the emulator-enabled media player 1112 to permit discovery of available content 1052.

In an illustrative example, the emulator-enabled media player 1112 includes an emulator 1114, a media drive 1116, and a content sink device 1118. In a particular example, the media drive 1116 can be a DVD drive and the content sink device 1118 can be an MPEG decoder. Functions performed by the emulator 1114 mirror, or emulate, the functions of the media drive 1116. In standard operation, the media drive 1116 supplies a media stream 1054 to the content sink device 1118 and requests a media description 1056. The emulator 1114 emulates functions of the media drive 1116, supplying an emulated media stream 1058, and requesting a media description 1059.

The emulator 1114 can use automatic Internet Protocol (IP) addressing to allocate reusable network addresses and configuration options.

The system may include a Dynamic Host Configuration Protocol (DHCP) server 1160 that supplies a framework for passing configuration information to hosts on a TCPIP network, based on a Bootstrap Protocol (BOOTP) that is known to those of ordinary skill in the art of network communication. The DHCP server 1160 adds a capability to automatically allocate reusable network addresses and additional configuration options 1162. DHCP captures the behavior of BOOTP relay agents to enable DHCP participants to interoperate with BOOTP participants.

Media structure requests are sent to the control point 1124. The media server 1120 transmits the media files to the renderer 1122. The control point 1124 creates menus in real-time by examining the media directories 1126.

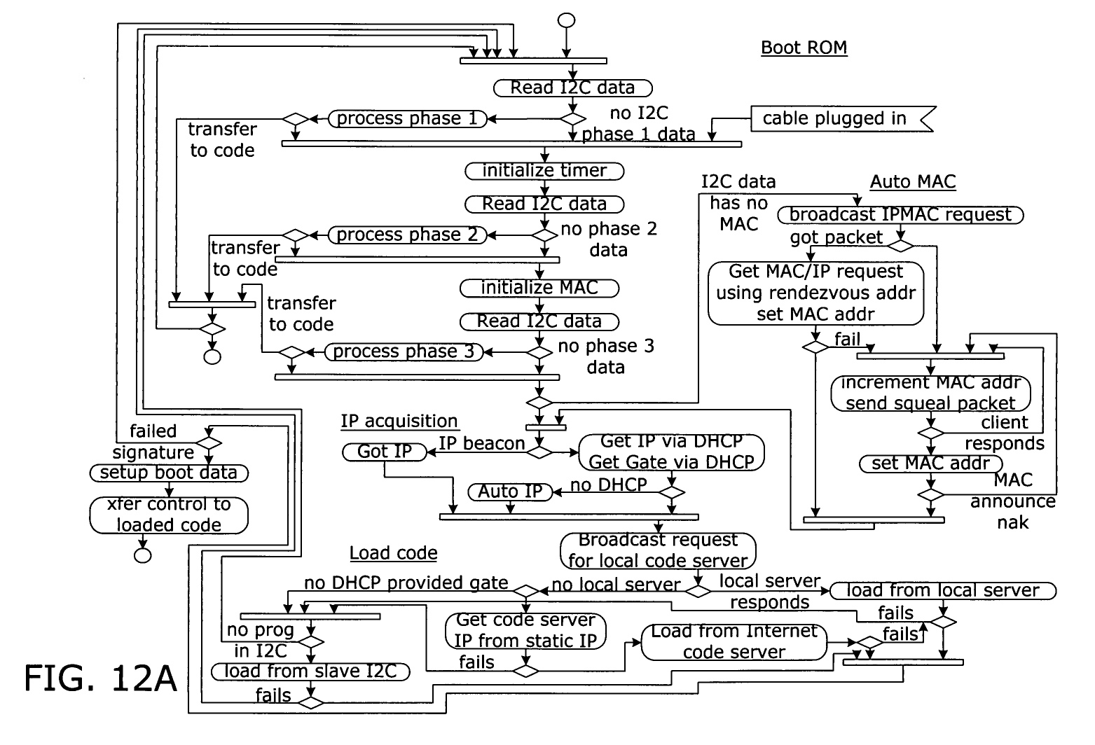

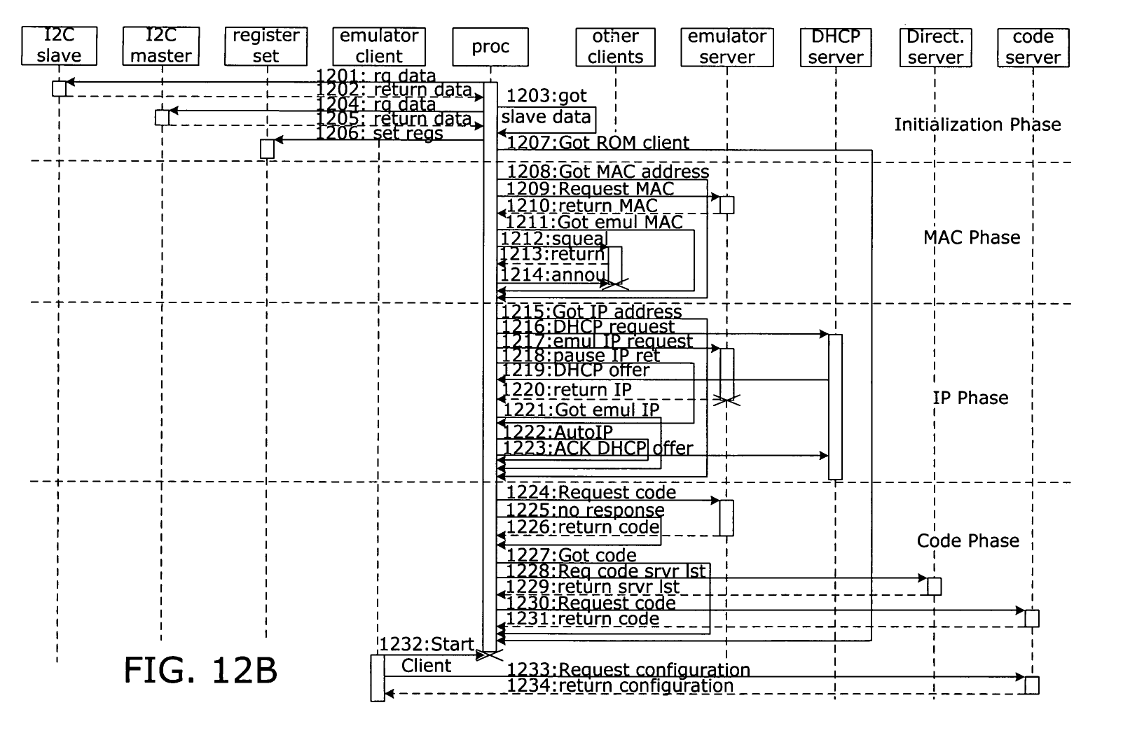

Referring to FIGS. 12A and 12B, a flow chart and sequence diagram respectively illustrate operations of a boot Read-Only Memory (ROM). The boot ROM attains control over a client at power-on/reset and executes until control is passed to a downloaded software image. The boot ROM configures Ethernet media access control (MAC) and IP addresses and attempts to contact a local or remote code server to enable downloading of a Client software image. The boot ROM may also receive a client download via Intelligent Interface Controller (12C) interfaces.

After MAC initialization and during network activity, boot ROM monitors the network cable and restarts network protocol activity when the cable becomes disconnected and reconnected.

All application-specific packets begin with a Zenith MUD Protocol (ZMP) header (ZMPHeader) defined as:

| | |
|---|---|
| typedef struct ZMPHeader_s { | |
| unsigned char Op; | |
| unsigned char Sub; | |
| unsigned char ProtocolMajorVer; | |
| unsigned char ProtocolMinorVer; | |
| unsigned char Configuration; | // for Clients switch values |
| | for servers OS |
| unsigned char pad; | |
| unsigned char Retries; | // attempts to perform the function |
| unsigned char Time; | // for ROM centisecs since |
| | reset, all others |
| } ZMPHeader; | |

The first element, “Op”, specifies the major classification of the packet, enabling efficient steering of a packet to a proper handler upon reception.

enum ZMP_OP_Codes {

| | | |
|---|---|---|
| ZMP_AutoMac | = 1, | // ZMP_Request, ZMP_Reply |
| ZMP_LocalBoot | = 2, | // request configuration: |
| | | ZMP_Request, supply config: |
| ZMP_INetDiscovery | = 3, | // code directory request |
| | | on the Internet |
| ZMP_ServerDiscovery | = 4, | |
| ZMP_Media | =5, | |
| ZMP_CodeRequest | = 6, | // sub=ZMP_Download for |
| | | local download |

| | |
|---|---|
| ZMP_MAESTROBEACON= 0xA0, | // sent only by |
| | MBOOTP server |
| ZMP_MAESTROREQUEST= 0xA1, | // sent only by client ROM |
| ZMP_MAESTROREPLY= 0Xa2, | // sent only by MBOOTP |
| | server |
| }; | |

Typedef ZMP_OP_Codes ZMPOPCodes ;

The second element, “Sub”, specifies a particular action within a packet's Op classification.

| enum ZMP_Sub_Codes { | | |
|---|---|---|
| ZMP_Request | = 1, | |
| ZMP_Reply | = 2, | |
| ZMP_MediaPort | = 3, | |
| ZMP_Download | = 4, | |
| ZMP_DISCOVER | = 5, | // client -> server |
| ZMP_OFFER | = 6, | // server-> client |
| ZMP_REQUEST | = 7, | // client -> server |
| ZMP_DECLINE | = 8, | // client -> server |
| ZMP_ACK | = 9, | // server-> client |
| ZMP_NACK | = 10, | // server-> client |
| ZMP_RELEASE | = 11, | // client -> server |
| ZMP_Beacon | = 12, | |
| ZMP_CodeServerList | = 13 | |
| }; | | |

Typedef ZMP_Sub_Codes ZMPSubCodes ;

The boot ROM attempts to locate a local server by making a local boot server request, via broadcast of a ZMPmbootp request. Requests are initiated in parallel with AutoMAC since a server can supply a MAC address for the client. Requests can be spaced at increasing time intervals for multiple requests to avoid network congestion for competing clients. Requests continue until a local server responds or a client software image is downloaded from another source. Boot ROM current values for MAC and IP are specified by the request packet. A server may respond with client IP, MAC, and Gate information. Non-zero values returned by the server in any of the fields can be adopted by the client boot ROM. An embodiment of a request packet format is as follows:

| | |
|---|---|
| typedef struct ZMPmbootp_s { | // configure client from local server: |
| | // ZMP_LocalBoot: |
| | ZMP_Request/ZMP_Reply |

```
  ZMPHeader Header;
  Unsigned int Xid;  // Transaction set by client
  Unsigned int UniqueIdentifier; // Set by client to further self-identify
  Unsigned int IP;  // client IP address
  Unsigned int IPMask;  // Mask for the local network
  Unsigned int IPGate;  // Gate to the Internet
  unsigned short Flags;  // not used
  unsigned char Hw_addr[HW_ADDR_LEN]; // client's HW (MAC)
  address
} ZMPmbootp;
```

AutoMAC protocol enables clients to autonomously select a MAC address from a selected address range. An example of an AutoMAC request packet follows:

| | |
|---|---|
| typedef struct ZMPSqueal_s { | // Self-configure MAC address: |
| | // ZMP_AutoMAC: |
| | ZMP_Request/ZMP_Reply |
| ZMPHeader Header; | |
| unsigned int Xid; | // Transaction set by client |
| unsigned int UniqueIdentifier; | // Set by client to further self-identify |
| unsigned char Flags; | // bit-0: 1 for last squeal |
| unsigned char pad; | |

unsigned char Hw_addr[HW_ADDR_LEN]; // candidate's address
} ZMPSqueal;

One operation involves random selection of an in-range MAC address, then sending of multiple ZMPSqueal requests and listening for replies. Any replies indicate that the given MAC address is already in use and a new random MAC address is to be tested. ZMPSqueal requests are sent multiple times with a selected delay between requests. If no replies are received, the candidate MAC address is adopted. If a reply is received before the sequence completes, the candidate MAC is abandoned and a new random candidate MAC address is selected, and the sequence is restarted. If at any point a server supplies a client MAC address, the AutoMAC operation is terminated.

If no server and/or DHCP server is detected, Automatic Private IP Addressing Protocol (APIPA) supplies a client IP address, enabling a client to connect to a similarly configured host.

A ZMPCodeRequest packet is sent to a server to initiate download of a client software image. The core of the request packet is a TFTP request header which includes the file name of a desired client software image. Subsequent data transfer and acknowledge packets follow the TFTP protocol specification. The downloaded image can be DSA-signed. The signature is validated and, if invalid, the boot ROM restarts operation. An example of a TFTP read request follows:

```
// TFTP read request
struct tftp_rrq {
  unsigned short cmd;  // TFTP_RRQ
            // ASCIIZ filename followed by ASCIIZ “binary” file type
    unsigned char
filename_mode[TFTP_MAX_FILENAME_LEN+1+
TFTP_MAX_MODE_LEN+1];
};
typedef struct ZMPCodeRequest_s {
  ZMPHeader Header;
  int Blocksize;
  struct tftp_rrq InitialRequest;
} ZMPCodeRequest;
```

The boot ROM requests a filed with a name encoded in a specified manner. The boot ROM contacts remote directory servers at one or more IP addresses if the local download is not complete within a specified time after MAC and IP configuration. A request with opcode:ZMP_InetDiscovery, subcode:ZMP_Request is sent to each of the defined IP addresses and if a response is received, the response packet will include one or more code-server IP/Port addresses that can be contacted to enable download of a client software image. An example of a request follows:

| typedef struct codeServerDescription_s { | |
|---|---|
| unsigned int Ip; | // IP to the code server |
| unsigned short port; | // port to contact the server |
| unsigned short flags; | // unused |

} CodeServerDescription;

All defined code addresses are queried with overlapping requests with multiple attempts and a specified timeout period. Requests are spaced in time to throttle gateway activity. The request includes only the ZMP header, while the reply includes the ZMPCodeServer payload defined as follows:

| | |
|---|---|
| //Request opcode:ZMP_INetDiscovery | subcode:ZMP_Request |
| //Replyopcode:ZMP_INetDiscovery | subcode:ZMP_Reply |

typedef struct ZMPCodeServer_s {

| | |
|---|---|
| //Request opcode: | subcode:ZMP_Request |
| ZMP_INetDiscovery | |
| // Reply opcode:ZMP_INetDiscovery | subcode:ZMP_Reply |

| | ZMPHeader Header; |
|---|---|
| | // the following structures repeat to the end of the reply packet |
| | CodeServerDescription Servers; |
| } | ZMPCodeServer; |

Any servers returned in replies are queued and contacted to request a Client software image download. Remote activity is only attempted if a gateway is specified via DHCP or remote server configuration.

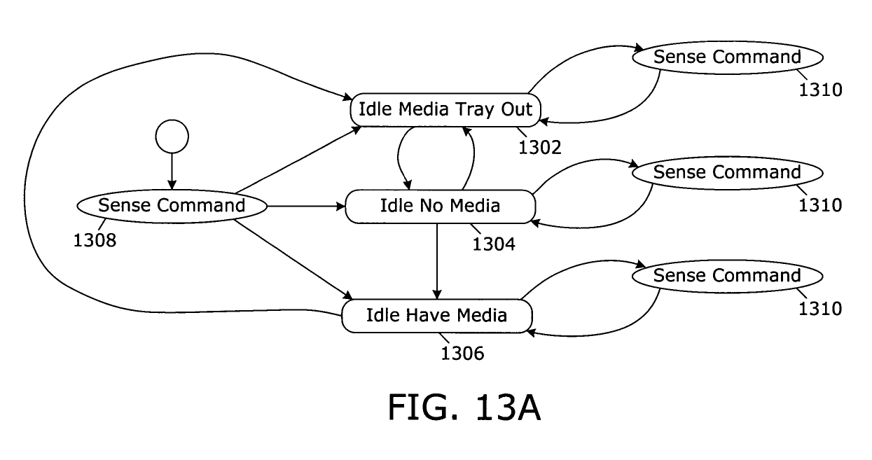

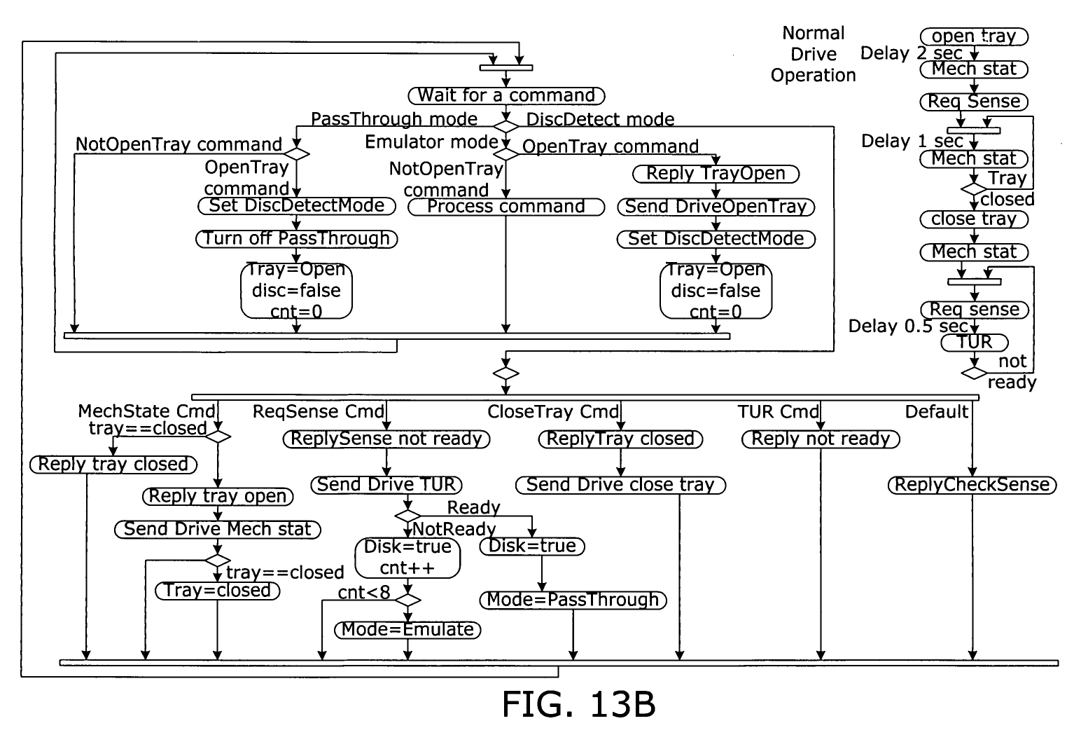

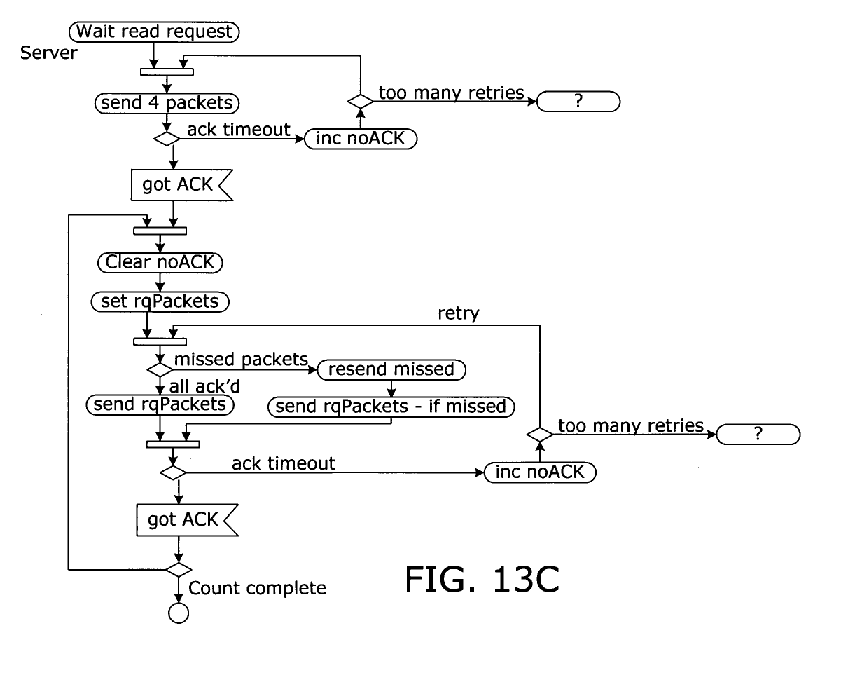

Referring to FIG. 13A, a schematic state diagram depicts an embodiment of drive controller 1300, such as the drive controller 162 shown in FIG. 1. States in the drive controller 1300 state diagram include an idle media tray out state 1302, an idle no media state 1304, and an idle have media state 1306. On initialization, the boot ROM sets up the interface 1308, for example an Integrated Drive Electronics (IDE) interface. In each state, the drive controller responds to a sense command 1310.

Referring to FIG. 13B, a flow chart illustrates an embodiment of drive interface operations.

In an illustrative embodiment, the client can have a server interface such as a Transmission Control Protocol (TCP) interface. The TCP interface is a simple socket with the client transmitting command packets and the server replying with the command packet specifying media state. The server responds by transmitting the requested number of data blocks. An example of a request block follows:

struct tNetCRB {

| | | |
|---|---|---|
| unsigned int | size; | // Total size of the packet+data to transfer |

| | | |
|---|---|---|
| unsigned char | device, | // Destination device COMSID |
| | command; | // Command to issue on server |

union {

| | |
|---|---|
| unsigned char cdb[12]; | // CDB, if needed |
| unsigned char sticky; | // Sticky bit - data |
| | should remain |

};

| | | |
|---|---|---|
| unsigned int | lba; | // Logical Block Address to read |
| unsigned int | count; | // Count of sectors to read |
| unsigned short | blocksize; | // Size of sector to read |
| unsigned int | fileSize; | // Size of file being transferred |
| unsigned int | bufferSize; | // Size of data that follows, |
| | | or of receiving buffer |
| unsigned int | encryptionID; | |

| | | |
|---|---|---|
| unsigned int | stickyBlocks | // Blocks always cached |
| | [MAX_StickyBlocks][2]; | |

| | |
|---|---|
| unsigned short iStack; | // Stack pointer |
| unsigned short mediaStack[MAX_MediaStack]; | // Media stack |

};

The mediaStack is not examined by the client but rather is state information that is acted upon only by the server.

Referring to FIG. 13C, a schematic flow chart illustrates an embodiment of operations performed by the client to implement UDP protocol communication, enabling rapid packet transmission without TCP overhead. The command channel is implemented over a TCP socket and data is transmitted over a UDP socket. The server tags each UDP transmission with a buffer position pointer. The pointer is used to place data into the buffer and assure that all packets arrive. Both the server and client have active timeouts coupled to retries in case of dropped packets. The number of packets between acknowledgements and the packet size are variable.

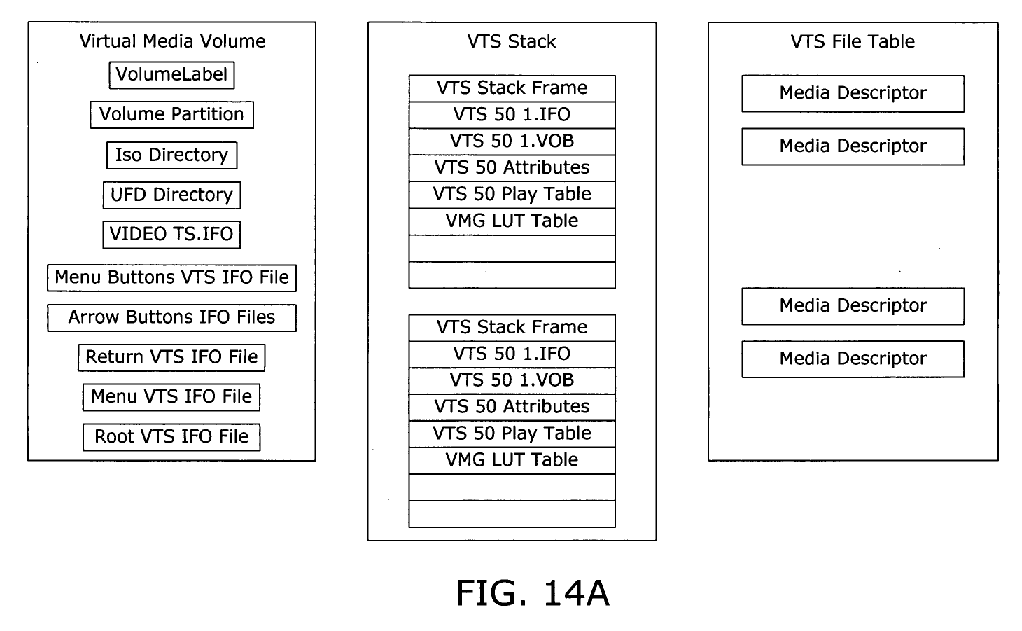

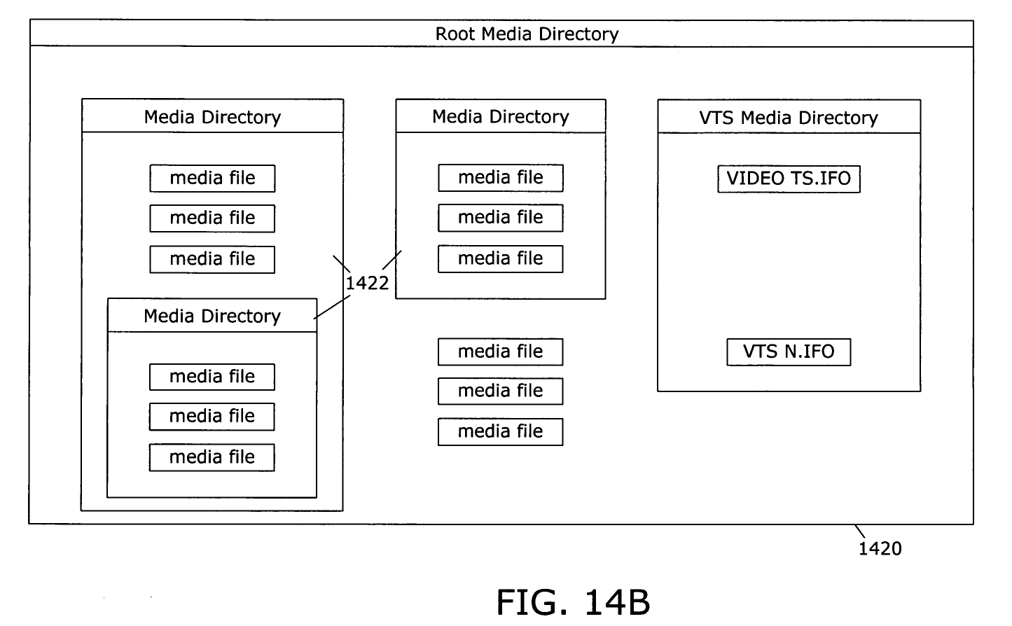

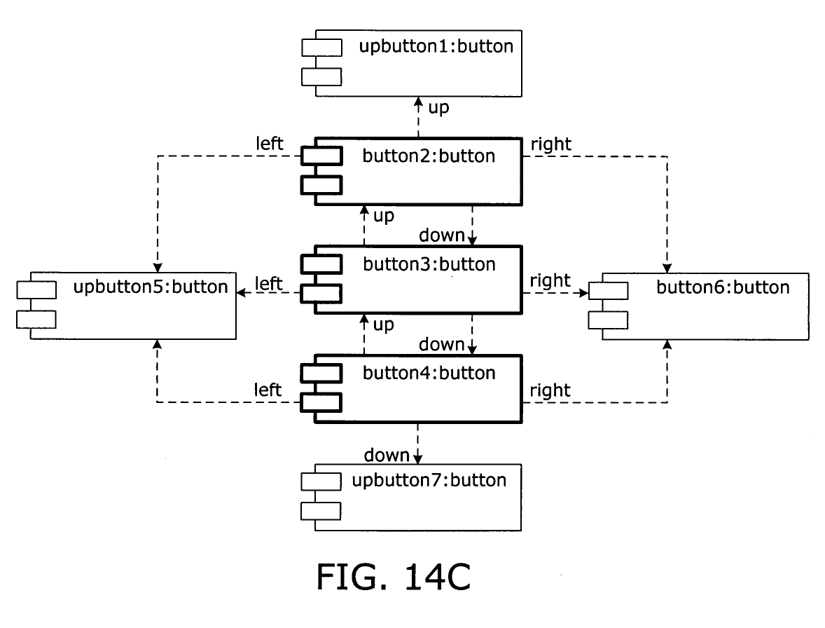

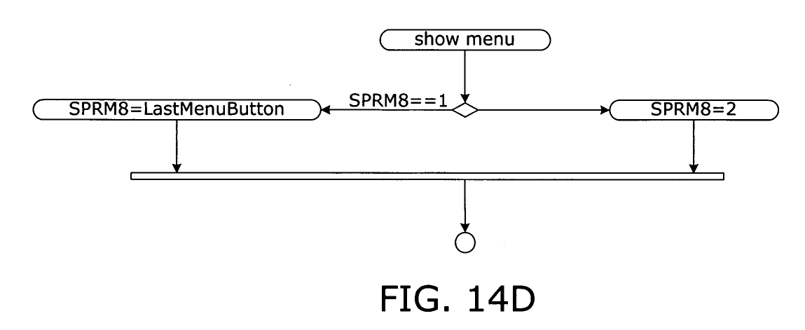

Referring to FIG. 14A, a schematic block diagram illustrates an embodiment of a media arrangement 1400 that can be used by the system. A Virtual media volume 1402 presents a “virtual” format to a user device, enabling navigation and play of the media in a user-friendly manner that is familiar to the user. Stack frames are held in a Video Title Set (VTS) stack 1404 by a client to preserve media space position. The navigation information enables a history mechanism within the user device to operate in a manner familiar to a user. Media descriptors 1406 associate stack frames to the media tree in VTS Tasks in a structure that enables the system to audit play histories and dynamically adjust storage resources and processor demands. Frequently-viewed material is automatically cached after first conversions to the user device's native format.

FIGS. 14B and 4 depict two views of the media, respectively a root media directory 1420 and a media tree 400. The two views express the media organization within the media delivery system, illustrating to the user device the manner in which the media can be distributed among multiple resources. The system dynamically and user-transparently configures the user interface by self-organizing the media, deriving navigation information by the location to the pieces of media in relation to one another. Media directories 1422 containing multiple pieces of media become menus and media pieces become source for selection of a user interface on the user device. FIG. 14C depicts linked menus representing the same media pieces as depicted in FIGS. 14B and 4, with the linked menus emphasizing scattering of the media pieces across multiple networks. The derived navigation information, in particular the menus, hold the linking information.

A player plays a single Title Set repeatedly while the system can substitute media from the distributed file system in that single Title Set, called Root Video Title Set (VTS) 1408. The VTS Stack 1404 preserves a user's position within the media tree 400 shown in FIG. 4 and the VTS File Table 1410 maps that position to a particular position in the media navigation tree 400. Stack frames are held by a client to preserve media space position. The navigation information enables the history functionality operative within the user device to operate in a manner that is typical for the user device, and generally known to the user. Media descriptors associate the stack frames to the media tree 400 in a structure that enables the system to audit play histories and dynamically adjust storage resources and processor demands. Frequently-viewed material can be automatically cached after first conversions to user device native format.

The linked menu diagram shown in FIG. 14C describes a Linked Menu Convention (LMC) which enables the transcoder and the client to present to the user a series of menus with a consistent look and feel. Navigation control and information is derived from file arrangements, enabling dynamic and user-transparent configuration of the user interface and dynamic access to selected content and sources. Directories become menus and media become buttons within the menus. If too large a number of media items are contained within a directory, a chaining of a series of menus is generated which appears to the user as successive menus that are familiar to the user. For example, for a user device that is a DVD player, the directories are presented in the form of successive DVD menus following the convention of DVD user interfaces. The convention is based upon the order of the button structures conveyed to the client in the eXtended Markup Language (XML) description of the media tree 400. The media tree 400 is coupled with the use of the GPRM's of the media player state machine, for example a DVD state machine, to enable self-contained free-standing media menu pages to appear to be mutually linked in a consistent and intuitive human interface. The convention groups any number of the separate menu pages into a menu set. A menu set is a group of menus that all are mutually inter-referenced and automatically transition to one another as the user depresses the arrow keys on the remote control.

The actions are based on conventions and attributes in the XML that describes the menu pages and the manner in which the elements are presented to the menu transcoder in the media system. A basic aspect of the convention is implementation of the automatic action button that is a native component of the media button specification. The automatic action button, for example may be a DVD button, which does not require the user to select the button for media state machine action to occur. Simply the action of the user to move a cursor to the button or “highlight” the button, is sufficient for the player to take an action, just as though the user had highlighted the button and then depressed the select or play button on the remote control.

The linked menu convention uses two additional attributes in the button element and one additional attribute for the menu element. The additional attributes in the button element include “AutoButton”, a simple true-false Boolean attribute indicating the button is an automatic action button, and DestiD, a transitions destination menu that enables transitions out of the normal menu hierarchy. DestID attribute holds the reference identifier IDREF of the destination menu, media, for example video, music, slideshow element, or the like, that is the target of the automatic action. IDREF is a unique identifier in the identifier attribute of every XML element. The menu element attribute is TCDR_LinkedMenu, a simple Boolean contained in the menu element attribute list and that is inferred to be false if absent from the menu element.

In an illustrative embodiment of the XML menu description for implementation of the Linked Menu Convention, the button presentation order in the menu XML element has meaning. For example in one implementation the first displayed button in the menu is an automatic-action button called an up button that, when highlighted, immediately executes a jump to the DestID element. The second button is the first media button in the Z order of the menu page. Whenever a jump is performed from a down auto-button of another Linked Menu Convention (LMC) menu within the set, the second button is the button on the new menu page that is highlighted. The last button in a menu belonging to a menu set is an automatic-action button called a down button that, once highlighted, immediately executes a jump to the next menu in the menu set. The last button in the navigation Z order of a LMC menu has a btnDown attribute that points to the LMC down button. No other non-automatic-action buttons can be positioned between this last media button and the final button specified on the menu, enabling a menu transcoder to easily select the button for inter-LMC menu navigation.

The last button of a menu is highlighted when a LMC menu is entered through the previous LMC's up button action in a redirection that is performed through a program incorporated into the IFO's of all LMC menus. For example, DVD players generally have a set of general purpose registers called GPRMs, and a set of special purpose registers called SPRMs. The LMC uses GPRM 1 to store the last media selection button. SPRM 8 is used to select a menu button for highlighting. The DVD program in the LMC menu IFO checks SPRM 8 to determine whether the previous menu's up button, for example button 1 in the Z order, has selected the menu. If so, the IFO program copies GPRM 1 into SPRM 8, causing the last media button of the newly selected LMC menu to be highlighted. The DVD IFO program then installs a last media button associated with the IFO program into GPRM 1 for the next transition in the LMC.

The buttons are contained within VTS Title Sets that are generated at the time media is added to the system. Because the menuing is developed in real-time using the transcoding process as the media tree changes, transcoders are also created to revise the menus that are affected by a change, deletion, or addition of media at the time the altered media state is encountered.

As shown in FIG. 14C, buttons 1, 5, 6, and 7 have the autoaction flag set, while buttons 2, 3, and 4, shown with heavy lines, are not auto-action. Button 2 is always the first media button. Button 4 is set into GPRM1 on entry to the menu.

Referring to FIG. 14D, a flow chart illustrates an embodiment of a code segment added to program code for information format (IFO) in cases that TCDR_LinkedMenu option is called on a transcoder. The call is made before any buttons are added to the transcoder.

The button element can be specified to include rightButton, leftButton, upButton, and downButton, that are declared for a particular application and can be implemented in XML as nvldRight, nlvdLeft, nvldUp, and nvldDown. The elements can be used to transfer button Z order to the menu transcoder and reference buttons in the order of appearance in the menu element. The button elements can be used as button destinations for passing the menu definition structure to the menu transcoder. In an illustrative embodiment, an LMC menu can be specified in XML as:

```
<menu id=“menu1” TCDR_LinkedMenu=“true”??>
  <button id=“2” nvld=“1” AutoButton=“true” DestID=“menu3”??/>
  <button id=“3” nvld=“2” nvldUp=“1” nvldDown=“3”??/>
    <video??/>
  <button id=“4” nvld=“3” nvldUp=“2” nvldDown=“4”??/>
    <video??/>
  <button id=“5” nvld=“4” AutoButton=“true” DestID=“menu3”??/>
</menu>
<menu id=“menu2” TCDR_LinkedMenu=“true”??>
  <button id=“26” nvld=“1” AutoButton=“true” DestID=“menu1”??/>
  <button id=“27” nvld=“2” nvldUp=“1” nvldDown=“3”??/>
    <video??/>
  <button id=“28” nvld=“3” nvldUp=“2” nvldDown=“4”??/>
    <video??/>
  <button id=“29” nvld=“4” AutoButton=“true” DestID=“menu3”??/>
</menu>
<menu id=“menu3” TCDR_LinkedMenu=“true”??>
  <button id=“32” nvld=“1” AutoButton=“true” DestID=“menu2”??/>
  <button id=“33” nvld=“2” nvldUp=“1” nvldDown=“3”??/>
    <video??/>
  <button id=“34” nvld=“3” nvldUp=“2” nvldDown=“4”??/>
    <video??/>
  <button id=“35” nvld=“4” AutoButton=“true” DestID=“menu1”??/>
</menu>
```

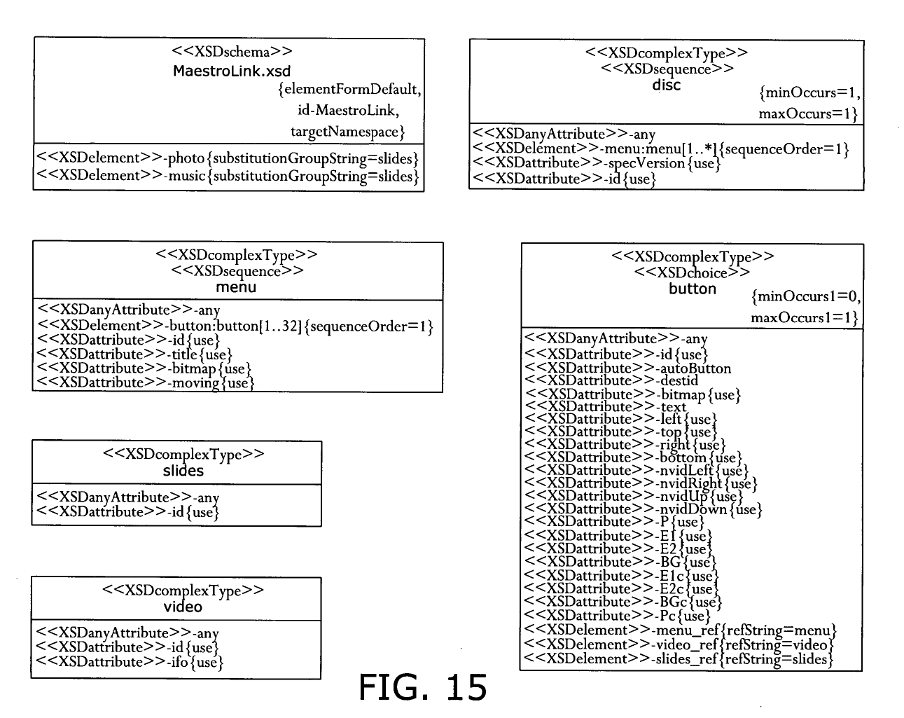

Referring to FIG. 15, a schematic block diagram illustrates an embodiment of an eXtended Markup Language (XML) media schema 1500. In an illustrative embodiment, the number of media elements is kept to a minimum to facilitate implementation and maintenance of XML compiler components of the server. Elements include one container called a disc element 1502, two navigation elements termed menu 1504 and button 1506 elements, and two media elements, video 1508 and slides 1510.

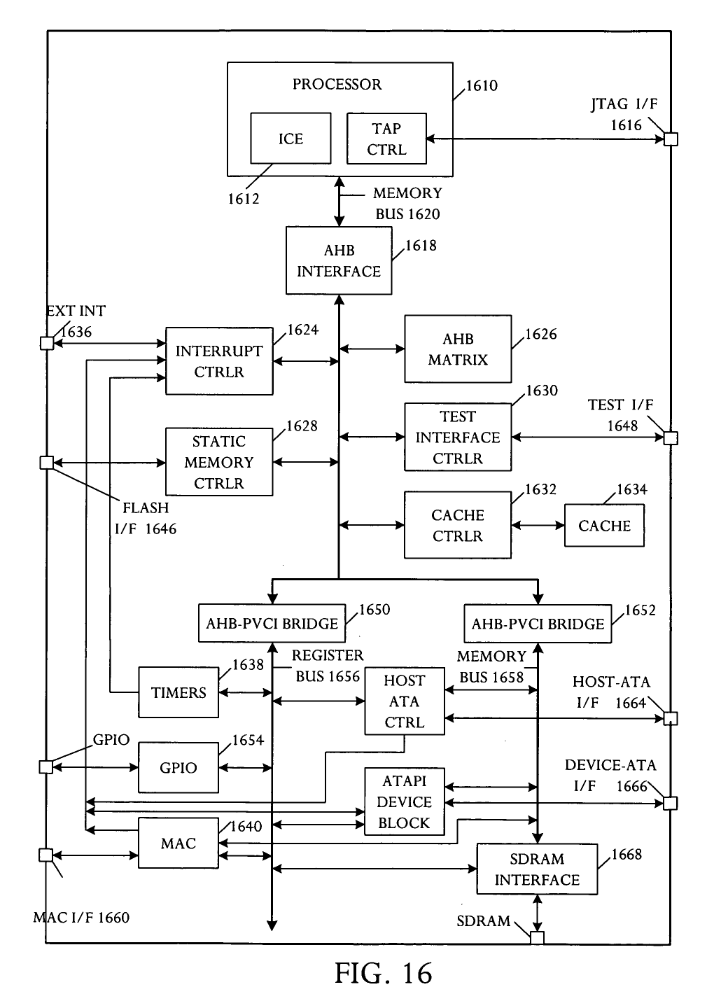

Referring to FIG. 16, a detailed block diagram depicts functional blocks of an emulation circuit 1600 that is suitable for usage in the emulator interface. In some embodiments, the emulation circuit 1600 can be implemented as a field programmable gate array, although other technologies may otherwise be used. The emulation circuit 1600 includes a processor 1610 that can be programmed to execute various functions including control, data transfer, emulation, transcoding, data storage, interface, test, and others. In an illustrative embodiment, the processor 1610 can be implemented as an ARM7TDMI-S manufactured by Advanced RISC Machines, United Kingdom. The illustrative processor 1610 further includes an in-circuit emulator 1612 and a Test Access Port (TAP) controller 1614.

The in-circuit emulator 1612 can support real-time debug with trace history around a trigger point, debugging of foreground tasks simultaneous with background task execution, and modification of memory during runtime. In-circuit emulator 1612 can also support multiple processors and mixed architecture devices, slow or variable-frequency designs, and debug of very low-voltage cores.

The TAP controller 1614 is coupled to a JTAG interface 1616, enabling the processor 1610 to execute JTAG emulation that allows the processor 1610 to be started and stopped under control of connected debugger software. JTAG emulation allows a user to read and modify registers and memory locations, set breakpoints and watchpoints, and support code download, trace, and monitoring for debug operations.

The processor 1610 and an AHB bus interface 1618 communicate on an ARM memory bus 1620. The AHB bus interface 1612 communicatively couples the processor 1610 to a multi-layer Advanced Microcontroller Bus Architecture (AMBA?) high-speed bus (AHB) 1622. AHB matrix 1626 is also coupled to the AHB 1622. The AHB Matrix 1626 is a complex interconnection matrix to attain parallel paths to memory and devices on the multi-layer AMBA? high-speed bus (AHB) 1622. The parallel paths of the AHB 1622 increase bus bandwidth and lower latencies by reducing contention. Multi-layer AHB 1622 is an interconnection technique based on AHB protocol that supports parallel access between multiple master and slave devices.

Devices coupled to the AHB 1622 include an interrupt controller 1624, a static memory controller 1628, a test interface controller 1630, a cache controller 1632, an AHB to PVCI bridge 1650, and an AHB to BVCI bridge 1652. The interrupt controller 1624 is capable of detecting interrupt signals from one or more sources including an external interrupt connection 1636, timers 1638, a media access control (MAC) module 1640, an ATAPI device block 1642, and a host ATA control block 1644. The interrupt controller 1624 asserts an appropriate bit identifying an interrupt on the processor 1610 upon the occurrence of one or more interrupt signals. In various applications, the current highest priority interrupt can be determined either by software or hardware. Typically, the current highest priority interrupt is read from a set of registers in the interrupt controller 1624. The interrupt controller 1624 contains registers indicative of interrupt status, and registers for enabling and setting interrupts.

The static memory controller 1628 is coupled to a flash memory interface 1646, typically for supplying program code that is executable on the processor 1610 although data and other information can also be supplied to the emulation circuit 1600.

The test interface controller 1630 is coupled to a test interface 1648 and supports external bus interface request and grant handshake signals for requesting test interface access to an external bus and information of external bus use grant, respectively. In a typical system, the processor 1610 may continually request access to an external bus with the test interface controller 1630 having highest priority to bus access. In a typical sequence of events to apply test patterns, first reset is asynchronously applied and synchronously removed. On reset removal, processor 1610 initiates a memory read via the static memory controller 1628. The static memory controller 1628 typically requests the external bus and reads the bus when the request is acknowledged. When the static memory controller 1628 is busy, the test interface controller 1630 can request the external bus. The request is granted because the test interface controller 1630 has the highest priority and the test interface controller 1630 takes ownership of the external bus. When the static memory controller 1628 finishes the read access, the test interface controller 1630 is granted use of the external bus. The external bus resolves the bus request signals and the test interface controller 1630 initiates a test pattern sequence.

The cache controller 1632 is coupled to a cache memory 1634, illustratively 4 kB of static RAM. The cache memory 1634 reduces external memory accesses and increases performance even with usage of relatively low-speed RAM. The cache memory 1634 allows processor 1610 to share bus bandwidth with multiple devices with high data throughput such as streaming audio and video devices.

The AHB to PVCI Bridge 1650 couples Peripheral Virtual Component Interface (PVCI) functional blocks to the AHB 1622. The AHB to PVCI bridge 1650 can include both master and slave interfaces and supports AHB Master to PVCI Slave and PVCI Master to AHB Slave modes. The PVCI standard enables development of plug-in components that are compatible with numerous interfaces, promoting design efficiency. In the illustrative example, PVCI devices coupled to a register bus 1656 include timers 1638, MAC module 1640, a general purpose input/output interface 1654, ATAPI device block 1642, and host ATA control block 1644.

The AHB to BVCI Bridge 1652 couples Basic Virtual Component Interface (BVCI) functional blocks to the AHB 1622. The Basic Virtual Component Interface (BVCI) is a system bus interface to a memory bus 1658. In the illustrative example, BVCI devices coupled to the AHB to BVCI bridge 1652 include the host ATA control block 1644, the ATAPI device block 1642, and a synchronous dynamic RAM (SDRAM) interface 1668.

Timers 1638 can be programmed to time various events under program control. The processor 1610 controls operation of timers 1638 through signals communicated to timer registers via the register bus 1656. The timers 1638 can generate timer interrupts that can redirect program execution through operation of the interface controller.

The emulation circuit 1600 receives and sends data or information by operation of the general purpose input/output interface 1654 that is coupled between the register bus 1656 and a GPIO interface 1662.

In the illustrative emulation circuit 1600, the MAC module 1640 is a 10/100-MBPS Ethernet media access controller for networking highly integrated embedded devices. The MAC module 1640 is coupled to an external network interface 1660, as well as to the register bus 1656 and the memory bus 1658. The MAC module 1640 is an interface to physical layer devices and can support 10-BaseT, 100-BaseTX, 100-BaseFX, and 32-bit standards-based BVCI bus interface with an integrated direct memory access (DMA) controller. The MAC module 1640 is typically IEEE 802.3 compliant and supports half- and full-duplex operation with collision detection, auto-retry, flow control, address filtering, wakeup-on-LAN, and packet statistics. MAC module 1640 can incorporate a DMA buffer-management unit and support wire-speed performance with variable packet sizes and buffer chaining. MAC module 1640 can offload processor tasks including such direct register access and programmable interrupts to improve high data throughput with little processor overhead. The MAC module 1640 can generate interrupts and includes an interrupt signal connection to the interrupt controller 1624.

The host ATA control block 1644 and the ATAPI device block 1642 are coupled to the register bus 1656 and the memory bus 1658, and operate in combination to facilitate connectivity between a host controller and hard disk drives in various applications including computing, communication, entertainment, peripheral, and other applications. The host ATA control block 1644 includes digital circuitry to form a complete ATA host subsystem to integrate hard disk, CD-ROM, DVD, DVD-R, and other host subsystems. The host ATA control block 1644 implements functionality for drive control and enables the emulation circuit 1600 to operate as a host. When the emulator 1600 functions as a host to control a storage drive the host uses functionality of host ATA control block 1644 and host ATA interface 1664. The host ATA control block 1644 can also implement programmed input-output (PIO), multiple-word direct memory access (DMA), and various speed, for example 33, 66, 100, and 133 megabyte/second, interface circuitry. In various embodiments, the host ATA control block 1644 can support multiple ATA/ATAPI devices. The host ATA control block 1644 is coupled to a host ATA interface 1664 for connecting to a host computer and has an interrupt connection to the interrupt controller 1624 so that the processor 1610 can address host ATA interface events.

The ATAPI device block 1642 is coupled to a device ATA interface 1666 and connects an Integrated Device Electronics (IDE) storage device to a host system. The ATAPI device block 1642 typically performs command interpretation in conjunction with the embedded processor 1610. The ATAPI device block 1642 implements functionality of storage drive emulation, enabling the emulation circuit 1600 to function as a storage drive. An external device can operate as a host that uses the emulation circuit 1600 as a drive. The ATAPI device block 1642 can be used to communicate with hard disk drives as well as solid-state storage devices using dynamic RAM (DRAM), NAND, or NOR flash memory devices, and the like. In various embodiments, the ATAPI device block 1642 can be designed to interface to one or more of various size (for example 1″, 1.8″, and 2.5″) hard disk drives, low-power drives, portable drives, tape drives, and solid-state or flash drives. The ATAPI device block 1642 has an interrupt connection to the interrupt controller 1624 so that the processor 1610 can address device ATA interface events.

The host ATA interface 1664 can be logically connected to the device ATA interface 1666. In one example, the emulation circuit 1600 can function as a MPEG decoder communicating directly with a storage drive. In a pass through operation, the emulator circuit 1600 can monitor commands sent to a storage drive passively.

The SDRAM interface 1668 is an interface controller that supports interconnection of the emulation circuit 1600 to synchronous dynamic RAM modules in various configurations, for example DIMM, without supporting circuitry. The SDRAM interface 1668 typically includes a SDRAM controller (not shown) and a SDRAM configuration block (not shown). The SDRAM controller generates control signals for controlling the SDRAM. The SDRAM configuration block includes configuration registers for controlling various entities such as refresh and mode lines, and a refresh timer for usage by the SDRAM controller. In various embodiments, the SDRAM interface 1668 SDRAM) interface 1668 can support slave devices, arbitrary length bus transfers, and programmability.

While the invention has been described with reference to various embodiments, it will be understood that these embodiments are illustrative and that the scope of the invention is not limited to them. Many variations, modifications, additions and improvements of the embodiments described are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the invention. Variations and modifications of the embodiments disclosed herein may be made based on the description set forth herein, without departing from the scope and spirit of the invention as set forth in the following claims.

What is claimed is:

1. An apparatus for handling media content comprising:
an interface that couples to and acquires content from one or more sources including network-coupled sources and/or locally-coupled sources, the one or more sources supplying various content;
a user interface; and
a controller that dynamically configures a user interface that enables selection and access of the content, the dynamic configuring being user-transparent.

2. The apparatus according to claim 1 wherein the controller automatically initiates user interface configuration in response to engagement of the apparatus with the one or more sources.

3. The apparatus according to claim 1 wherein the controller configures the user interface in content groups.

4. The apparatus according to claim 1 further comprising:
the interface that acquires the content from the one or more sources in a plurality of different formats;
a transcoder that converts the content to a common format for presentation; and
a client device that presents the content in a client device common format.

5. The apparatus according to claim 4 wherein:
the conversion is user-transparent.

6. The apparatus according to claim 1 further comprising:
said interface that acquires the content from the one or more sources in a plurality of different formats;
a decoder that decodes the content into a format compatible for presentation; and
a client device that presents the content in a client device common format.

7. The apparatus according to claim 6 wherein the decoder is selected from among a group comprising:
multiple client-resident decoders; at least one programmable client-resident decoder reconfigured by downloading multiple versions of client-resident decoder code;
and decoder code downloaded in combination with content.

8. The apparatus according to claim 1 further comprising:
a server executable on the controller that derives navigation information based on relative location of content elements on the one or more sources and organizes the content from the navigation information.

9. The apparatus according to claim 1 further comprising:
a client device; and
a server executable on the controller that arranges content elements and navigation information in virtual media volumes forming a distributed file system and including a single title set, the client device repeatedly playing the single title set as the server substitutes content from the single title set.

10. The apparatus according to claim 9 further comprising:
the distributed file system including a Video Title Set (VTS) stack and a VTS file table, the VTS stack that preserves a user's position within a media tree and the VTS file table mapping the user's position to a location in a media navigation tree.

11. The apparatus according to claim 10 further comprising:
stack frames in the VTS stack that are held by a client to preserve media space position, the server using media descriptors to associate stack frames to the media tree.

12. An apparatus for handling media content comprising:
a client device; and
a server that arranges content elements and navigation information in virtual media volumes forming a distributed file system and including a single title set, the client device repeatedly playing the single title set as the server substitutes content from the single title set.

13. The apparatus according to claim 12 further comprising:
the distributed file system including a Video Title Set (VTS) stack and a VTS file table, the VTS stack that preserves a user's position within a media tree and the VTS file table mapping the user's position to a location in a media navigation tree.

14. The apparatus according to claim 13 further comprising:
stack frames in the VTS stack that are held by a client to preserve media space position, the server using media descriptors to associate stack frames to the media tree.

15. A content handling method comprising:
acquiring content from one or more sources including sources capable of network connection and/or sources capable of local connection, the content and sources being capable of dynamic change; and
dynamically configuring a user interface that enables selection and access of the content, the dynamic configuring being user-transparent.

16. The method according to claim 15 further comprising:
engaging a user device for usage with the user interface with the one or more sources; and
automatically configuring the user interface in response to the engagement.

17. The method according to 15 further comprising:
configuring the user interface in content groups.

18. The method according to claim 15 further comprising:
acquiring the content from the one or more sources in a plurality of different formats; and
converting the content to a common format for presentation, the conversion being user-transparent; and
presenting the content in the common format on a user device.

19. The method according to claim 15 wherein:
the user device and at least one of the local connection sources are consumer electronics devices.

20. The method according to claim 15 further comprising:
acquiring the content from the one or more sources in a plurality of different formats; and
processing the content into a format compatible for presentation; and
presenting the content in the common format on a user device.

21. The method according to claim 15 further comprising:
deriving content navigation information from relative location of content items.

22. The method according to claim 15 further comprising:
organizing the content based on the derived content navigation information.

23. The method according to claim 15 further comprising:
arranging content items in a tree structure of directories; and
displaying the directories as a menu for source selection by the user.

24. The method according to claim 23 further comprising:
using the arranged content items as a source for a user interface selection on the user device.

25. The method according to claim 15 further comprising:
arranging the content items in a tree structure of directories distributed across multiple networks.

26. An apparatus for handling media content comprising:
an interface that couples to and acquires content from one or more sources including network-coupled sources and/or locally-coupled sources, the one or more sources supplying various content; and
a controller that derives navigation information from the one or more sources based on relative location of the sources and organizes the content into an internal map mutually relating the sources.

27. The apparatus according to claim 26 further comprising:
a user interface coupled to the controller, the controller that arranges content items in a tree structure of directories and displays the directories via the user interface as a menu.

28. The apparatus according to claim 27 further comprising:
a client device coupled to the controller, the controller that uses the arranged content items as a source for user interface selection on the client device and arranges the content items in a tree structure of directories distributed across multiple networks.

29. A content handling method comprising:
deriving navigation information from one or more sources including sources capable of network connection and/or sources capable of local connection based on relative location of the sources; and
organizing the content into an internal map mutually relating the sources.

30. The method according to claim 29 further comprising:
arranging content items in a tree structure of directories; and
displaying the directories as a menu for source selection by the user.

31. The method according to claim 30 further comprising:
using the arranged content items as a source for a user interface selection on the user device.

32. The method according to claim 31 further comprising:
arranging the content items in a tree structure of directories distributed across multiple networks.

33. A server comprising:
a media monitor that supplies streaming content media from one or more various media content sources;
a virtual media driver that arranges and stores the media content in a virtual file structure;
a media server that presents content media of various types to the virtual media driver; and
a processor that acquires content from the one or more sources via the media monitor, evaluates acquired content form for definition of further content processing to a form that can be presented on a client, and processing the acquired content into a form that can be presented on the client, the acquisition, evaluation, and processing being user-transparent.

34. The server according to claim 33 wherein the processor transcodes the content into a form that can be presented on the client.

35. The server according to claim 33 further comprising:
one or more server-resident decoders capable of converting the content into a form that can be presented on the client, wherein the processor selects from the one or more decoders.

36. The server according to claim 33 further comprising:
one or more programmable server-resident decoders, wherein the processor reconfigures a decoder of the one or more decoders by downloading a version of server-resident decoder code separately or in combination with content, the one or more decoders that convert the content into a form that can be presented on the client.

37. The server according to claim 33 wherein:
the content and sources are capable of dynamic modification.

38. The server according to claim 33 wherein:
the media monitor supplies streaming content from one or more sources including sources capable of network connection and sources capable of local connection.

39. A content handling method comprising:
acquiring content from one or more sources, the content and sources being capable of changing dynamically;
evaluating acquired content form for definition of further content processing to a form that can be presented on a user device; and
processing the acquired content into a form that can be presented on the user device, the acquisition, evaluation, and processing being user-transparent.

40. The method according to claim 39 further comprising:
transcoding the content into a form that can be presented on a client.

41. The method according to claim 39 further comprising:
selecting from one or more of multiple, server-resident, decoders for use to convert the content into a form that can be presented on the client; and
decoding the content using the selected decoder.

42. The method according to claim 41 further comprising:
downloading one or more versions of server-resident decoder code separately or in combination with content; and
reconfiguring the one or more decoder code versions according to the downloading to effect conversion of the content into a form that can be presented on a client.

43. The method according to claim 42 further comprising:
acquiring the content from one or more sources including sources capable of network connection and sources capable of local connection, the content and sources being capable of dynamic change.

44. The method according to claim 42 further comprising:
dynamically configuring a user interface that enables selection and access of the content, the dynamic configuring being user-transparent.

45. The method according to claim 42 further comprising:
deriving content navigation information from relative location of content items; and
organizing the content based on the derived content navigation information.

46. The method according to claim 42 further comprising:
arranging content items in a tree structure of directories;
displaying the directories as a menu for source selection by the user; and
using the arranged content items as a source for a user interface selection on the user device.

47. The method according to claim 42 further comprising:
arranging the content items in a tree structure of directories distributed across multiple networks.

48. The method according to claim 42 further comprising:
generating a virtual media volume for presentation to the user device, the virtual media volume being a distributed file system;
continuously replaying a single title set of the virtual media volume; and
dynamically substituting media from the distributed file system in the single title set.

49. The method according to claim 42 further comprising:
converting the acquired content into the form presentable on the user device in real time.

50. A content handling method comprising:
generating a virtual media volume for presentation to a user device, the virtual media volume being a distributed file system;
continuously replaying a single title set of the virtual media volume; and
dynamically substituting media from the distributed file system in the single title set.

51. An apparatus for handling media content comprising:
an interface that couples to and acquires use and navigation information from at least one content source in one or more formats;
a user interface; and
a controller that incorporates the use and navigation information into a menuing display of the user interface and accesses content from the at least one source based on the use and navigation information, the acquisition, incorporation, and access being user-transparent.

52. The apparatus according to claim 51 wherein:
the controller generates a distributed file system virtual media volume for presentation to the user interface and derives navigation information from file arrangement of the distributed file system.

53. The apparatus according to claim 51 wherein:
the controller generates directories in a distributed file system and
displays directories via the user interface as menus whereby media content elements are displayed as menu buttons.

54. The apparatus according to claim 51 wherein:
the at least one content source includes sources capable of network connection and sources capable of local connection, the content and sources being capable of dynamic change.

55. The apparatus according to claim 51 wherein:
the use and navigation information changes intermittently; and
the controller updates the menuing display in real-time in response to the intermittently changed use and navigation information.

56. A content handling method comprising:
acquiring use and navigation information from at least one content source in one or more formats;
incorporating the use and navigation information into a menuing display of a user device; and
accessing content from the at least one source based on the use and navigation information, the acquisition, incorporation, and access being user-transparent.

57. The method according to claim 56 further comprising:
generating a virtual media volume for presentation to the user device, the virtual media volume being a distributed file system; and
deriving navigation information from file arrangement of the distributed file system.

58. The method according to claim 56 further comprising:
generating directories in a distributed file system; and
displaying directories as menus whereby media content elements are displayed as menu buttons.

59. The method according to claim 56 further comprising:
the at least one content source includes sources capable of network connection and sources capable of local connection, the content and sources being capable of dynamic change.

60. The method according to claim 56 wherein the use and navigation information changes intermittently, the method further comprising:
updating the menuing display in response to the intermittently changed use and navigation information.

61. The method according to claim 60 further comprising:
updating the content form in real-time.

62. An apparatus for handling media content comprising:
an interface between a plurality of content sources and at least one sink device; and
a controller coupled to the interface that determines format or formats of content on the plurality of content sources and processes the format or formats to a format compatible with the at least one sink device without user interaction.

63. The apparatus according to claim 62 wherein:
the interface couples to and acquires content from one or more sources including network-coupled sources and locally-coupled sources, the one or more sources supplying content of multiple various types.

64. The apparatus according to claim 62 wherein:
the controller evaluates acquired content form for definition of a processing to a form displayable on the sink device, and processes the acquired content into a form displayable on the sink device, the acquisition, evaluation, and processing being user-transparent.

65. A method for managing content comprising:
determining format or formats of a plurality of content sources; and
processing the format or formats to a format compatible with a sink device without user interaction.

66. A method for managing content on a user device comprising:
acquiring use and navigation information from one or more sources in at least one format;
deriving a combination of the use and navigation information;
incorporating the information combination into a menuing display of the user device; and
accessing content from the at least one source based on the information combination without requiring any additional information from the user.

67. A method for automatically accessing media content comprising:
interfacing to a plurality of diverse sources supplying media content in multiple formats, the sources and media content being capable of dynamic modification;
organizing the media content according to navigation information derived from relative location of the media and sources;
displaying the media content organization as a user interface for selecting a media content element for access; and
accessing a selected media content element.

68. The method according to claim 67 further comprising:
dynamically configuring a user interface that enables selection and access of the content, the dynamic configuring being user-transparent.
